(19) United States
(12) Patent Application Publication
(10) Pub. No.: US 2025/0111305 A1
(43) Pub. Date: Apr. 3, 2025

(54) ESTIMATION METHOD AND ESTIMATION DEVICE

(71) Applicant: Panasonic Intellectual Property Corporation of America, Torrance, CA (US)

(72) Inventors: Katsunori DAIMO, Osaka (JP); Taketoshi NAKAO, Kyoto (JP)

(21) Appl. No.: 18/980,330

(22) Filed: Dec. 13, 2024

Related U.S. Application Data
(63) Continuation of application No. PCT/JP2023/019081, filed on May 23, 2023.

(30) Foreign Application Priority Data
Jun. 22, 2022 (JP) 2022-100193

(51) Int. Cl. G06Q 10/0631; G06V 40/20

(52) U.S. Cl. CPC G06Q 10/063114; G06V 40/20

(57) ABSTRACT

An estimation method is an estimation method, performed by a computer, of estimating a task performed by a worker, and includes: obtaining data of a task sound that accompanies the task and that has been collected; and estimating whether the worker is performing a task in which a transparent object is handled, by inputting the data of the task sound into a first model that has been trained.

### CROSS REFERENCE TO RELATED APPLICATIONS

This is a continuation application of PCT International Application No. PCT/JP2023/019081 filed on May 23, 2023, designating the United States of America, which is based on and claims priority of Japanese Patent Application No. 2022-100193 filed on Jun. 22, 2022. The entire disclosures of the above-identified applications, including the specifications, drawings and claims are incorporated herein by reference in their entirety.

### FIELD

The present disclosure relates to an estimation method and the like that estimates tasks done by a worker.

### BACKGROUND

A first step in improving productivity in a factory is to automatically collect data on tasks performed by workers, classify the tasks, and measure the time spent on each class of work. For example, Patent Literature (PTL) 1 discloses a technique for classifying tasks by identifying objects (e.g., transparent objects) handled in the tasks from images captured under multiple image capturing conditions.

### CITATION LIST

### Patent Literature

PTL 1: Japanese Unexamined Patent Application Publication No. 2018-017653

### SUMMARY

### Technical Problem

However, with the technique described in PTL 1, if the transparency of the object is high, or if there is little change in the refractive index or reflectance of light in the object, the accuracy with which the object is identified will drop, even if the image capturing conditions are changed. The technique described in PTL 1 may therefore not be able to accurately estimate tasks in which highly transparent objects (“transparent objects”, hereinafter) are handled.

Accordingly, the present disclosure provides an estimation method and the like capable of accurately estimating tasks in which transparent objects are handled.

### Solution to Problem

An estimation method according to one aspect of the present disclosure is an estimation method, performed by a computer, of estimating a task performed by a worker. The estimation method includes: obtaining data of a task sound that accompanies the task and that has been collected; and estimating whether the worker is performing a task in which a transparent object is handled, by inputting the data of the task sound into a first model that has been trained.

### Advantageous Effects

According to the present disclosure, tasks in which transparent objects are handled can be estimated accurately.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an example of the functional configuration of an estimation system according to an embodiment.

FIG. 2 is a flowchart illustrating Operation Example 1 of the estimation system according to the embodiment.

FIG. 3 is a diagram schematically illustrating an example of the flow in step S02 of FIG. 2.

FIG. 4 is a graph showing a similarity between a feature of a collected task sound and a feature of a task sound in a task in which a transparent object is handled.

FIG. 5 is a graph illustrating a result of analyzing one hour's worth of task sounds in time series in Verification Example 1.

FIG. 6 is a diagram illustrating a method for estimating a bag task performed in Verification Example 3.

FIG. 7 is a diagram illustrating an example of the architecture of a neural network.

FIG. 8 is a diagram illustrating a method for calculating an accuracy rate when estimating two classes.

FIG. 9 is a diagram illustrating estimation results and accuracy rates of two classes in Verification Example 3.

FIG. 10 is a diagram illustrating a method for calculating an accuracy rate when estimating three classes.

FIG. 11 is a diagram illustrating estimation results and accuracy rates of three classes in Verification Example 3.

FIG. 12 is a diagram illustrating a method for estimating two classes and a method for calculating an accuracy rate using a combination of input data.

FIG. 13 is a diagram illustrating estimation results and accuracy rates of two classes using a combination of input data in Verification Example 3.

FIG. 14 is a diagram illustrating a result of comparing the estimation accuracy of an estimation method using image AI and an estimation method according to Operation Example 1.

FIG. 15 is a diagram illustrating a difference between a result of estimation using data of a task sound and a result of estimation using data of an image.

FIG. 16 is a diagram illustrating an overview of the flow of Operation Example 2 of the estimation system according to the embodiment.

FIG. 17 is a flowchart illustrating Operation Example 2 of the estimation system according to the embodiment.

FIG. 18 is a flowchart illustrating Variation 1 on Operation Example 2 of the estimation system according to the embodiment.

FIG. 19 is a diagram schematically illustrating Configuration Example 1 of an estimator that performs the flow of Variation 1 on Operation Example 2.

FIG. 20 is a diagram illustrating a method for estimating a bag task performed by Configuration Example 1.

FIG. 21 is a diagram schematically illustrating Configuration Example 2 of an estimator that performs the flow of Variation 1 on Operation Example 2.

FIG. 22 is a diagram schematically illustrating Configuration Example 3 of an estimator that performs the flow of Variation 1 on Operation Example 2.

FIG. 23 is a diagram illustrating an example of the architecture of an image subnetwork.

FIG. 24 is a diagram illustrating an example of the architecture of a sound subnetwork.

FIG. 25 is a diagram illustrating an example of the architecture of a fusion layer.

FIG. 26 is a diagram illustrating an example of the architecture of a classification network.

FIG. 27 is a diagram illustrating an example of the architecture of a contrastive learning network.

FIG. 28 is a diagram schematically illustrating a configuration example of an estimator that performs the flow of Variation 2 on Operation Example 2.

FIG. 29 is a diagram illustrating an example of a task sound when a worker is erroneously estimated by the estimator to be performing a task in which a transparent object is handled.

FIG. 30A is a flowchart illustrating Operation Example 3 of the estimation system according to the embodiment.

FIG. 30B is a flowchart illustrating an example of operations for pre-registering features of task sounds that can be erroneously estimated.

FIG. 31 is a block diagram illustrating an example of the functional configuration of an estimation system according to another embodiment.

### DESCRIPTION OF EMBODIMENTS

### Underlying Knowledge Forming Basis of Present Disclosure

A first step in improving productivity in a factory is to automatically collect data on tasks performed by workers, classify the tasks, and measure the time spent on each class of work. This enables the user to understand which tasks take time for the workers, which makes it possible to create a work plan through which the workers can work more efficiently.

Thus far, tasks performed by workers are captured by a camera, and the tasks are classified by identifying the objects handled by the workers. For example, in PTL 1, a transparent object is identified from a plurality of images captured under different image capturing conditions, and the task is classified as one in which the worker is handling a transparent object. However, it is difficult to identify an object having high transparency (a “transparent object”) from an image if the transparency is high or if there is little change in the refractive index or reflectance of light in the object, even if the image capturing conditions are changed. The technique described in PTL 1 may therefore not be able to accurately estimate tasks in which transparent objects are handled.

There is thus a need for a method capable of accurately classifying tasks performed by workers by accurately identifying objects and accurately estimating tasks in which transparent objects are handled, even if the transparency of the object being handled in the task is high or if there is little change in the refractive index or reflectance of light in the object.

In past methods, the main focus has been on capturing a still object with a camera and identifying the object. Accordingly, the inventors of the present disclosure found that collecting task sounds accompanying a task (i.e., the sounds produced by the task) makes it possible to accurately estimate a task in which a transparent object is handled, even if the transparent object is moved or deformed in the task performed by the worker.

### Overview of the Present Disclosure

An estimation method according to Example 1 of one aspect of the present disclosure is an estimation method, performed by a computer, of estimating a task performed by a worker. The estimation method includes: obtaining data of a task sound that accompanies the task and that has been collected; and estimating whether the worker is performing a task in which a transparent object is handled, by inputting the data of the task sound into a first model that has been trained.

Through this, the device that performs the estimation method uses the first model, which takes the data of the task sound as an input and outputs whether the task is one in which a transparent object is handled, which makes it possible to accurately estimate tasks in which a transparent object is handled.

An estimation method according to Example 2 of one aspect of the present disclosure may be the estimation method according to Example 1, further including: obtaining data of an image in which the worker performing the task appears, the data of the image corresponding to the data of the task sound; estimating whether the worker is performing the task in which the transparent object is handled, by inputting the data of the image into a second model that has been trained; and estimating whether the worker is performing the task in which the transparent object is handled, based on a result of the estimating using the first model and a result of the estimating using the second model. Note that the estimation result using the first model is an estimation result estimated from the data of the task sound by the first model, and the estimation result using the second model is an estimation result estimated from the data of the image by the second model.

Through this, the device that performs the estimation method estimates whether the worker is performing a task in which a transparent object is handled based on the estimation result estimated from the data of the task sound by the first model and the estimation result estimated from the data of the image by the second model. Accordingly, the device that performs the estimation method can estimate tasks in which a transparent object is handled more accurately than when estimating using only the data of the task sound.

An estimation method according to Example 3 of one aspect of the present disclosure may be the estimation method according to Example 1, further including: obtaining data of an image in which the worker performing the task appears, the data of the image corresponding to the data of the task sound; and estimating whether the worker is performing the task in which the transparent object is handled, by inputting the data of the task sound and the data of the image into the first model.

Through this, the device that performs the estimation method uses the first model, which takes the data of the task sound and the data of an image corresponding to the task sound as an input and outputs whether the task is one in which a transparent object is handled, which makes it possible to estimate tasks in which a transparent object is handled more accurately than when estimating using only the data of the task sound.

An estimation method according to Example 4 of one aspect of the present disclosure may be the estimation method according to any one of Example 1 to Example 3, further including: estimating whether the worker is performing the task in which the transparent object is handled, based on a similarity between a feature of the task sound output from the first model and a feature, stored in storage in advance, of a task sound of the task in which the transparent object is handled.

Through this, the device that performs the estimation method estimates whether the worker is performing a task in which a transparent object is handled based on the similarity between the feature of the task sound output from the first model and the feature of the task sound of a task in which a transparent object is handled, which makes it possible to accurately estimate tasks in which a transparent object is handled.

An estimation method according to Example 5 of one aspect of the present disclosure may be the estimation method according to any one of Example 1 to Example 4, further including: estimating whether the worker is performing the task in which the transparent object is handled, based on a similarity of a feature of the task sound output from the first model to each of (i) a feature of a task sound, stored in advance in storage, of the task in which the transparent object is handled and (ii) a feature of a task sound, stored in advance in the storage, from which the worker can be erroneously estimated to be performing the task in which the transparent object is handled.

Through this, the device that performs the estimation method can reduce the occurrence of erroneous estimations by comparing the similarity between the feature of a task sound output from the first model and a feature of a task sound of a task in which a transparent object is handled with a similarity between the feature of the task sound output from the first model and a feature of a task sound that can be erroneously estimated. Accordingly, the device that performs the estimation method can accurately estimate tasks in which a transparent object is handled even when using only the data of the task sound.

An estimation method according to Example 6 of one aspect of the present disclosure may be the estimation method according to Example 5, wherein the worker is estimated to be performing the task in which the transparent object is handled when the similarity of the feature of the task sound output from the first model to the feature of the task sound of the task in which the transparent object is handled exceeds the similarity to the feature of the task sound from which the worker can be erroneously estimated to be performing the task in which the transparent object is handled.

Through this, the device that performs the estimation method can reduce the occurrence of erroneous estimations, which makes it possible to accurately estimate tasks in which a transparent object is handled even when only the data of the task sound is used.

An estimation method according to Example 7 of one aspect of the present disclosure may be the estimation method according to Example 5 or Example 6, further including: when a similarity of (i) a feature of a task sound of a task in which a non-transparent object different from the transparent object is handled, the feature being obtained by inputting, to the first model, data of the task sound of the task in which the non-transparent object is handled, to (ii) the feature of the task sound of the task in which the transparent object is handled, exceeds a threshold, determining that the task sound of the task in which the non-transparent object is handled is a task sound that can be erroneously estimated as a task sound of the task in which the transparent object is handled; and storing, in the storage, the feature of the task sound of the task in which the non-transparent object is handled as the feature of the task sound that can be erroneously estimated.

Through this, based on a similarity between the feature of a task sound of a task in which a non-transparent object is handled and the feature of a task sound of a task in which a transparent object is handled, the device that performs the estimation method can accurately determine whether the task sound of the task in which the non-transparent object is handled is a task sound that can be erroneously estimated as being a task sound of a task in which the transparent object is handled. Accordingly, the device that performs the estimation method can store the features of task sounds which are relatively likely to be erroneously estimated in storage. As such, the device that performs the estimation method can reduce the occurrence of erroneous estimations by using the feature of a task sound that can be erroneously estimated, stored in the storage, which makes it possible to accurately estimate tasks in which a transparent object is handled even when only the data of the task sound is used.

An estimation method according to Example 8 of one aspect of the present disclosure may be the estimation method according to any one of Example 1 to Example 7, wherein the data of the task sound includes data of a sound in an inaudible range.

Through this, the device that performs the estimation method estimates whether the worker is performing a task in which a transparent object is handled using the data of a task sound including sound from an audible range to an inaudible range. Including sound in an inaudible range in the data of the task sound ensures the data of the task sound contains less environmental noise, which can cause erroneous estimations, and thus the device that performs the estimation method can increase the accuracy of estimating tasks in which a transparent object is handled. Furthermore, the device that performs the estimation method can estimate whether the worker is performing a task in which a transparent object is handled based on more information than when using only data of sound in an audible range. Accordingly, the device that performs the estimation method can more accurately estimate tasks in which a transparent object is handled.

An estimation device according to Example 9 of one aspect of the present disclosure is an estimation device that estimates a task performed by a worker. The estimation device includes: an obtainer that obtains data of a task sound that accompanies the task and that has been collected; and an estimator that estimates whether the worker is performing a task in which a transparent object is handled by inputting the data of the task sound into a first model that has been trained.

Through this, the estimation device uses the first model, which takes the data of the task sound as an input and outputs whether the task is one in which a transparent object is handled, which makes it possible to accurately estimate tasks in which a transparent object is handled.

Additionally, a program according to Example 10 of one aspect of the present disclosure is a program for causing a computer to execute the estimation method according to any one of Example 1 to Example 8.

Accordingly, the same effects as those of the above-described estimation method can be achieved using a computer.

Note that these comprehensive or specific aspects may be realized by a system, a method, a device, an integrated circuit, a computer program, or a computer-readable recording medium such as a Compact Disc Read Only Memory (CD-ROM), or may be implemented by any desired combination of systems, methods, devices, integrated circuits, computer programs, and recording media.

Embodiments of the present disclosure will be described in detail hereinafter with reference to the drawings. The numerical values, shapes, materials, constituent elements, arrangements and connection states of constituent elements, steps, orders of steps, and the like in the following embodiments are merely examples, and are not intended to limit the scope of the claims. Additionally, of the constituent elements in the following embodiments, constituent elements not denoted in the independent claims, which express the broadest interpretation, will be described as optional constituent elements. Additionally, the drawings are not necessarily exact illustrations. Configurations that are substantially the same are given the same reference signs in the drawings, and redundant descriptions may be omitted or simplified.

Additionally, in the present disclosure, terms indicating relationships between elements, such as “parallel” and “perpendicular”, terms indicating the shapes of elements, such as “rectangular”, and numerical values do not express the items in question in the strictest sense, but rather include substantially equivalent ranges, e.g., differences of several percent, as well.

### Embodiment

An embodiment will be described in detail hereinafter with reference to the drawings.

### 1. Overview

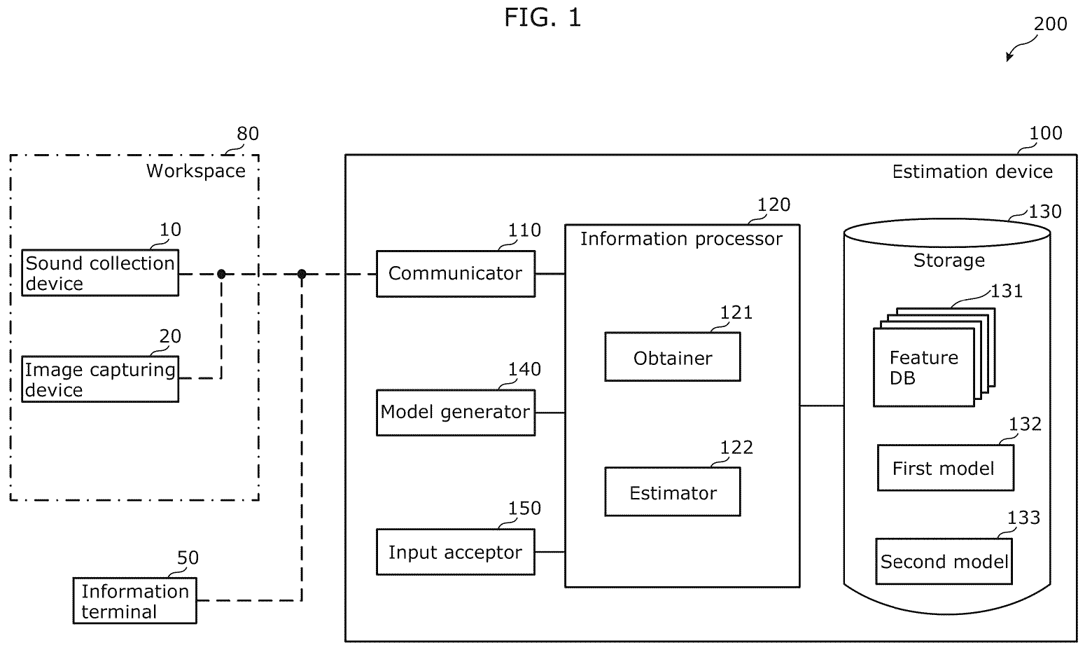

First, an overview of the estimation system according to the embodiment will be described. FIG. 1 is a block diagram illustrating an example of the functional configuration of estimation system 200 according to the embodiment.

Estimation system 200 is a system that estimates a task performed by a worker. Estimation system 200 is a system that estimates whether a worker is performing a task in which a transparent object is handled by, for example, obtaining a task sound accompanying the task, collected by sound collection device 10, and inputting data of the task sound into a trained first model 132 (also called simply “first model 132” hereinafter).

For example, estimation system 200 may present an estimation result estimated by estimation device 100 to a user by displaying the result on a display of information terminal 50. Through this, the user can refer to the estimation result to ascertain the time required for a task in which a transparent object is handled and for a task in which a non-transparent object is handled, and the user can also refer to the estimation result to create a work plan for the worker. This makes it possible to increase the efficiency of tasks performed in workspace 80.

A task sound accompanying a task includes a sound that occurs with the task. The task sound is, for example, a sound produced when an object handled by the worker is moved, deformed, or the like. The task is, for example, picking, cleaning, inspecting, packing, or the like of a component. Workspace 80 is a space in which the worker works, e.g., in a manufacturing plant or a logistics warehouse.

The transparent object is a highly-transparent object, and is formed from a highly-transparent material such as a synthetic resin, glass, or the like, for example. “High transparency” means, for example, when the object is in the form of a sheet, or when the object is configured of an item in the form of a sheet, that haze of the sheet is less than 0.5%; or, when the object is in the form of a flat plate or a block, or when the object is configured of an item in the form of a flat plate or a block, the refractive index of light is at least 1.30 and at most 1.70. The transparent object is, for example, a container, a bag, a cushioning material, a component, or the like.

The “synthetic resin” may be, for example, a vinyl resin such as polyvinyl chloride resin, a polycarbonate resin, a polyester resin, a polyethylene naphthalate resin, a polyethylene resin, a polypropylene resin, a polyimide resin, a polystyrene resin, a urethane resin, an acrylic resin, a fluorine resin, or the like. Note that the material constituting the highly-transparent object is not limited to the foregoing examples, and may include, for example, a natural polymer such as microfibrous cellulose.

Note that estimation system 200 may estimate whether the worker is performing a task in which the transparent object is handled by obtaining data of an image, captured by image capturing device 20, in which the worker performing the task appears, and inputting the obtained data of the image and the data of the task sound into first model 132; or may estimate whether the worker is performing a task in which the transparent object is handled based on an estimation result obtained by inputting the data of the image into a trained second model 133 (also called simply “second model 133” hereinafter) and an estimation result obtained by inputting the data of the task sound into first model 132. The data of the image corresponds to the data of the task sound.

### 2. Configuration

The configuration of estimation system 200 according to the embodiment will be described next with reference to FIG. 1.

Estimation system 200 includes, for example, sound collection device 10, image capturing device 20, information terminal 50, and estimation device 100. Sound collection device 10 and image capturing device 20 are installed in a space in which the worker performs tasks (workspace 80), and are communicably connected to information terminal 50 and estimation device 100. Note that the configuration of estimation system 200 illustrated in FIG. 1 is merely an example, and the configuration is not limited thereto.

### Sound Collection Device 10

Sound collection device 10 collects a task sound that accompanies a task performed by a worker, for example. Sound collection device 10 is installed in workspace 80, for example. Sound collection device 10 is capable of collecting sounds from an audible range to an inaudible range. The audible range is a frequency band that can be perceived by the human ear, and the inaudible range is a frequency band that cannot be perceived by the human ear. The sound in the inaudible range is a sound in a frequency band of, for example, at least 20 kHz. More specifically, sound collection device 10 is a microphone, e.g., a Micro Electro Mechanical Systems microphone, or a laser microphone.

If implemented as a laser microphone, for example, sound collection device 10 is capable of collecting a wider range of sounds than a normal microphone. A laser microphone also does not have a diaphragm like a normal microphone, which makes it possible to collect sound even in environments where electromagnetic waves are present, high-temperature or high-heat environments, and the like.

Although FIG. 1 illustrates an example in which estimation system 200 includes one sound collection device 10, two or more sound collection devices 10 may be included. Sound collection device 10 may also be a directional microphone. This makes it difficult for sound collection device 10 to collect sounds that act as noise, such as ambient sounds, and thus the task sound can be collected with a high level of sensitivity.

Sound collection device 10 converts the collected sound (task sound) into an electrical signal and outputs the electrical signal to estimation device 100. Note that sound collection device 10 may add a timestamp and its own identification number to the collected task sound data before outputting the data to estimation device 100.

### Image Capturing Device 20

Image capturing device 20 captures an image in which the worker performing the task appears. The data of the image corresponds to the data of the task sound collected by sound collection device 10. In other words, image capturing device 20 operates in conjunction with sound collection device 10, and may, for example, add a timestamp to the obtained data (the data of the task sound and the data of the image) to associate the data of the task sound with the data of the image. At this time, for example, image capturing device 20 may add its own identification number to the image data. Image capturing device 20 is installed in workspace 80, for example. Image capturing device 20 is, for example, an RGB camera, but may include distance data.

Image capturing device 20 outputs the data of the captured image to estimation device 100.

### Information Terminal 50

Information terminal 50 is an information terminal used by the user, e.g., a personal computer, a tablet terminal, or the like. Information terminal 50 displays estimation results estimated by estimation device 100 on a display. Information terminal 50 also accepts instructions input by the user and sends those instructions to sound collection device 10, image capturing device 20, and estimation device 100.

### Estimation Device 100

Estimation device 100 is a device that estimates a task performed by a worker. Estimation device 100 estimates whether a worker is performing a task in which a transparent object is handled by, for example, obtaining data of a task sound accompanying the task, collected by sound collection device 10, and inputting the data of the task sound into the trained first model 132.

For example, as illustrated in FIG. 1, estimation device 100 includes communicator 110, information processor 120, storage 130, model generator 140, and input acceptor 150. Estimation device 100 is, for example, a server device. Although estimation device 100 includes second model 133 in the example in FIG. 1, second model 133 does not absolutely have to be included. The various constituent elements of estimation device 100 will be described hereinafter.

### Communicator 110

Communicator 110 is communication circuitry (a communication module) for estimation device 100 to communicate with sound collection device 10 and image capturing device 20. Communicator 110 includes communication circuitry (a communication module) for communicating over a wide-area communication network, but may include communication circuitry (a communication module) for communicating over a local communication network. Communicator 110 is, for example, wireless communication circuitry for communicating wirelessly, but may be wired communication circuitry for communicating over wires. Note that the communication standard of the communication by communicator 110 is not particularly limited.

### Information Processor 120

Information processor 120 performs various types of information processing pertaining to estimation device 100. More specifically, for example, information processor 120 obtains data of a task sound collected by sound collection device 10 (e.g., an electrical signal of the task sound) and performs various types of information processing pertaining to the estimation of whether a worker is performing a task in which a transparent object is handled. For example, information processor 120 may obtain data of an image in which a worker performing a task, captured by image capturing device 20, appears, and perform various types of information processing pertaining to the estimation of whether the worker is performing a task in which a transparent object is handled. Information processor 120 may estimate the task using the data of the task sound, or may estimate the task using the data of the task sound and the data of the image. Specifically, information processor 120 includes obtainer 121 and estimator 122. The functions of obtainer 121 and estimator 122 are realized by a processor or microcomputer constituting information processor 120 executing computer programs stored in storage 130.

### Obtainer 121

Obtainer 121 obtains, for example, the data of the task sound collected by sound collection device 10. The data of the task sound is a sound that accompanies a task performed by the worker, and is a sound that occurs with the task performed by a worker, for example. Obtainer 121 also obtains data of an image in which the worker performing the task appears, corresponding to the data of the task sound, captured by image capturing device 20, for example. The data of the task sound may be an image of a spectrogram generated through a Fourier transform performed on the electrical signal of the task sound collected by sound collection device 10, or may be time-series numerical data.

### Estimator 122

Estimator 122 estimates, when the data of the task sound is obtained by obtainer 121, whether the worker is performing a task in which a transparent object is handled, based on the data of the task sound. Estimator 122 estimates, for example, whether the worker is performing a task in which a transparent object is handled by inputting the data of the task sound into the trained first model 132 (“first model 132” hereinafter). Specifically, for example, estimator 122 estimates whether the worker is performing a task in which a transparent object is handled based on a similarity between a feature of the task sound output from first model 132 and a feature of a task sound, stored in storage 130 (e.g., in feature database 131 within storage 130) in advance, of a task in which a transparent object is handled. More specifically, for example, estimator 122 may input the data of the task sound into first model 132; calculate the similarity between the feature of the task sound of the task in which the transparent object is handled, extracted by first model 132, and the feature of the task sound of the task in which a transparent object is handled, stored in storage 130 in advance; and estimate that the worker is performing a task in which the transparent object is handled when the calculated similarity is at least a predetermined value (i.e., a threshold). However, the configuration is not limited to this example, and estimator 122 may use a model that directly outputs an estimation result of whether the worker is performing a task in which a transparent object is handled based on the data of the task sound.

In addition, when obtainer 121 obtains the data of an image in which the worker performing the task appears, corresponding to the data of the task sound, estimator 122 may estimate whether the worker is performing the task in which the transparent object is handled, based on the data of the task sound and the data of the image. Specifically, for example, estimator 122 estimates whether the worker is performing a task in which a transparent object is handled by inputting the data of the task sound and the data of the image in which the worker performing the task appears, corresponding to the data of the task sound, into first model 132. First model 132 will be described in detail later.

For example, if estimation device 100 includes the trained second model 133, when the data of the image is obtained by obtainer 121, estimator 122 estimates whether the worker is performing a task in which the transparent object is handled by inputting the data of the image into second model 133. At this time, estimator 122 estimates whether the worker is performing a task in which the transparent object is handled by inputting, into first model 132, the data of the task sound of the task performed by the worker appearing in the data of the image obtained by obtainer 121. Estimator 122 then estimates whether the worker is performing a task in which a transparent object is handled based on the estimation result estimated from the data of the image using second model 133 and the estimation result estimated from the data of the task sound using first model 132.

Estimator 122 may also determine, for example, whether the task sound collected by sound collection device 10 is a task sound that can be erroneously estimated to be a task sound of a task in which a transparent object is handled. Specifically, when, for example, a similarity between (i) a feature of a task sound of a task in which a non-transparent object different from the transparent object is handled, obtained by inputting the data of a task sound of a task in which the non-transparent object is handled into first model 132, and (ii) a feature of a task sound of a task in which a transparent object is handled, exceeds a predetermined value (i.e., a threshold), estimator 122 determines that the task sound of the task in which the non-transparent object is handled can be erroneously estimated by estimator 122 to be a task sound of a task in which a transparent object is handled. Estimator 122 then stores the feature of the task sound determined to be a task sound that can be erroneously estimated in feature database 131 (feature DB) of storage 130.

Note that feature database 131 may store a feature of a task sound of a task in which a transparent object is handled, which has been stored in advance. Feature database 131 will be described later.

### Storage 130

Storage 130 is a storage device that stores a dedicated application program and the like through which information processor 120 performs various types of information processing. For example, feature database 131, first model 132, and second model 133 are stored in storage 130. Storage 130 may be implemented as a Hard Disk Drive (HDD), for example, but may be implemented as semiconductor memory.

Feature database 131 stores features of task sounds extracted in advance. Each feature may be expressed as a numerical value or a combination of numerical values, such as embeddings (e.g., tensors, matrices, and the like), embedded vectors, or distributed representations. For example, feature database 131 may store features of task sounds that accompany tasks in which a transparent object is handled, and features of task sounds that can be erroneously estimated as tasks in which a worker handles a transparent object. Feature database 131 may also store features of images extracted in advance. For example, feature database 131 may store a feature of an image in which a worker performing a task in which a transparent object is handled appears (specifically, a feature indicating a transparent object appearing in the image).

First model 132 is, for example, a trained model generated by model generator 140. First model 132 takes the data of the task sound as an input, and outputs whether the worker is performing a task in which a transparent object is handled, for example. More specifically, for example, first model 132 extracts a feature of task sound data that has been input; calculates a similarity between the extracted feature and a feature of a task sound of a task in which a transparent object is handled, stored in storage 130 in advance; and estimates that the worker is performing a task in which a transparent object is handled when the calculated similarity is at least a predetermined value. First model 132 may further take data of an image in which the worker performing the task appears, corresponding to the data of the task sound, as an input, and output whether the worker is performing a task in which the transparent object is handled. More specifically, for example, first model 132 may extract a feature of image data that has been input; calculate a similarity between the extracted feature and a feature of an image in which a worker performing a task in which a transparent object is handled appears, stored in storage 130 in advance; and estimate that the worker is performing a task in which a transparent object is handled when the calculated similarity is at least a predetermined value.

Second model 133 is a trained model generated by model generator 140. Second model 133 takes data of an image in which the worker performing the task appears, corresponding to the data of the task sound, as an input, and outputs whether the worker is performing a task in which the transparent object is handled. More specifically, for example, second model 133 may extract a feature of image data that has been input; calculate a similarity between the extracted feature and a feature of an image in which a worker performing a task in which a transparent object is handled appears, stored in storage 130 in advance; and estimate that the worker is performing a task in which a transparent object is handled when the calculated similarity is at least a predetermined value.

Note that first model 132 and second model 133 may extract a feature of the input data and output the extracted feature.

Specifically, first model 132 and second model 133 are neural network models, and may be, for example, a convolutional neural network (CNN), a recurrent neural network (RNN), or a Long-Short Term Memory (LSTM).

### Model Generator 140

Model generator 140 generates first model 132 and second model 133 by performing machine learning using labeled data. For example, model generator 140 generates a sound identification model (also called an “acoustic subnetwork” hereinafter) which, through machine learning, takes the data of the task sound as an input and outputs whether the worker is performing a task in which the transparent object is handled. Additionally, for example, model generator 140 may further generate an image identification model (also called an “image subnetwork” hereinafter) which, through machine learning, takes the data of an image in which the worker performing the task appears, corresponding to the data of the task sound, as an input and outputs whether the worker is performing a task in which the transparent object is handled. First model 132 may be a sound identification model, or may be a model that includes a sound identification model and an image identification model, for example. The data of the task sound input to first model 132 may be an image of a spectrogram, or may be time-series numerical data, for example. The data of the task sound may include data of a sound in an inaudible range.

Additionally, model generator 140 may generate an image identification model (e.g., second model 133) that, through machine learning, takes the data of an image as an input and outputs a feature indicating a transparent object that appears in the image.

As described above, for example, the sound identification model extracts a feature of task sound data that has been input; calculates a similarity between the extracted feature and a feature of a task sound of a task in which a transparent object is handled, stored in storage 130 in advance; and estimates that the worker is performing a task in which a transparent object is handled when the calculated similarity is at least a predetermined value. Additionally, the image identification model extracts a feature of image data that has been input; calculates a similarity between the extracted feature and a feature of an image in which a worker performing a task in which a transparent object is handled appears, stored in storage 130 in advance; and estimates that the worker is performing a task in which a transparent object is handled when the calculated similarity is at least a predetermined value. Note that the model including the sound identification model and the image identification model estimates whether the worker is performing a task in which a transparent object is handled based on estimation results obtained using these two models.

Model generator 140 may update first model 132 and second model 133 by storing the trained models in storage 130. Model generator 140 is implemented by, for example, a processor executing a program stored in storage 130.

Note that first model 132 and second model 133 may extract a feature of the input data and output the extracted feature.

### Input Acceptor 150

Input acceptor 150 is an input interface that accepts operational inputs from a user using estimation device 100. Specifically, input acceptor 150 is realized by a touch panel display or the like. For example, if input acceptor 150 is equipped with a touch panel display, the touch panel display functions as a display (not shown) and input acceptor 150. Note that input acceptor 150 is not limited to a touch panel display, and may be, for example, a keyboard, a pointing device (e.g., a stylus or a mouse), physical buttons, or the like. Additionally, if inputs made by voice are accepted, input acceptor 150 may be a microphone.

### 3. Examples of Operations

Examples of operations of estimation system 200 according to the embodiment will be described next.

### Operation Example 1

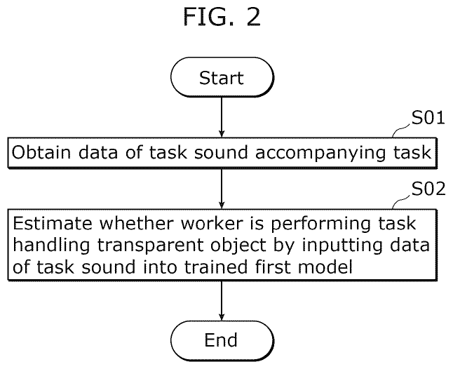

Operation Example 1 of estimation system 200 according to the embodiment will be described first with reference to FIG. 2. FIG. 2 is a flowchart illustrating Operation Example 1 of estimation system 200 according to the embodiment.

Although not illustrated in FIG. 2, in estimation system 200, for example, sound collection device 10 collects a task sound accompanying a task performed by a worker, and outputs data of the collected task sound to estimation device 100.

Obtainer 121 of estimation device 100 obtains the data of the task sound collected by sound collection device 10 (S01), and outputs the obtained data of the task sound to estimator 122.

Next, estimator 122 of estimation device 100 estimates whether the worker is performing a task in which a transparent object is handled by inputting the data of the task sound into the trained first model 132 (S02).

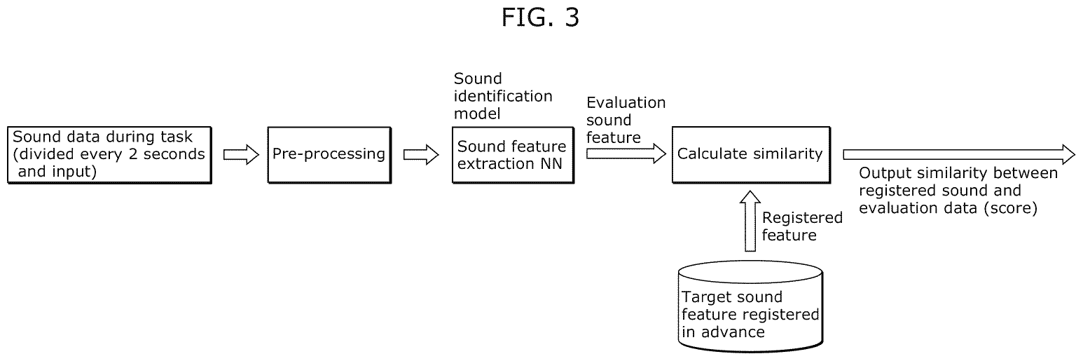

Step S02 will be described in further detail hereinafter. FIG. 3 is a diagram schematically illustrating an example of the flow in step S02 of FIG. 2. For example, estimator 122 divides sound data from when a task is performed (i.e., the data of the task sound), obtained from obtainer 121, into data of predetermined units of time (e.g., two seconds), and inputs the divided data into the sound identification model (e.g., first model 132). At this time, as illustrated in FIG. 3, pre-processing such as normalization may be performed on the data of the task sound before being input to the sound identification model. The sound identification model extracts a feature of a task sound of a task in which a transparent object is handled from the input data of the task sound. Here, the feature extracted by the sound identification model will be called a “feature to be evaluated”, i.e., an “evaluation sound feature”.

Next, estimator 122 calculates a similarity indicating how similar the evaluation sound feature output from the sound identification model is to a registered feature, which is a feature of a task sound of a task in which a transparent object is handled (called a “target sound” here) that is registered in advance in storage 130, and outputs the calculated similarity.

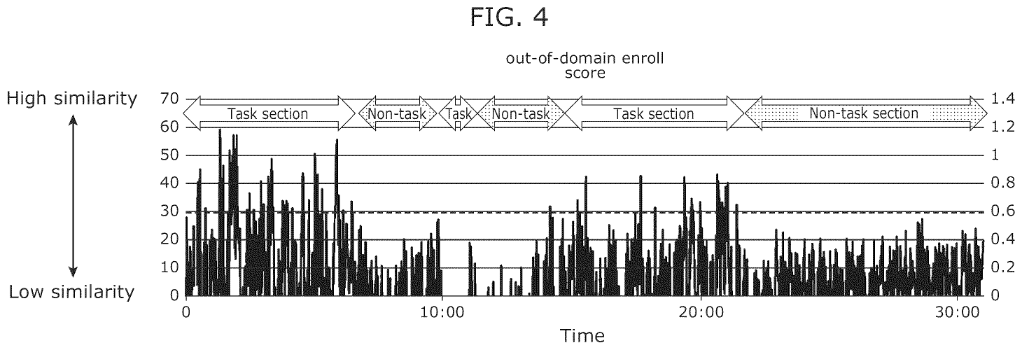

FIG. 4 is a graph showing a similarity between a feature of a collected task sound and a feature of a task sound in a task in which a transparent object is handled. FIG. 4 also indicates a result of a user visually confirming an image captured by image capturing device 20 and distinguishing between sections in which a worker is performing a task in which a transparent object is handled (called “task sections” here) and sections in which the worker is not performing a task in which a transparent object is handled (called “non-task sections” here). The broken line in the graph indicates a threshold for the similarity. For example, the worker is estimated to be performing a task in which a transparent object is handled when the similarity of a feature of a task sound extracted by the sound identification model to a feature of a task sound in which a transparent object is handled, registered in advance, is at least a threshold (30, here). As illustrated in FIG. 4, the differences between task sections and non-task sections are represented by similarity scores. For example, the similarity score increases when a sound produced by handling a transparent object (e.g., a plastic bag, a cushioning material, or the like) is collected. On the other hand, during, for example, a section in which a transparent object is placed on a workbench but the worker is not touching the transparent object, no sound produced by the transparent object is collected, and the similarity score is therefore not calculated.

### Verification Example 1 of Operation Example 1

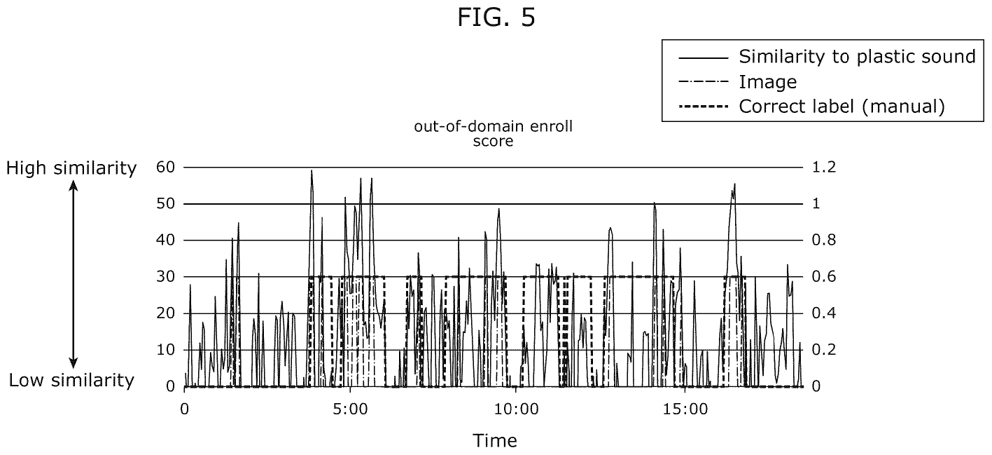

Verification Example 1, in which the accuracy of the task estimation in Operation Example 1 is verified, will be described next. In Verification Example 1, one hour's worth of task sounds were analyzed in time series. FIG. 5 is a graph illustrating a result of analyzing one hour's worth of task sounds in time series in Verification Example 1. In Verification Example 1, the transparent object is a transparent plastic bag (called a “transparent bag” hereinafter), and a similarity between (i) a feature of the task sound that accompanies the task performed by the worker, obtained by inputting data of the task sound into first model 132 (e.g., the sound identification model in FIG. 3), and (ii) a feature of a task sound that accompanies a task in which a transparent bag is handled, registered in advance, is calculated. Although the data of the task sound collected in Verification Example 1 is data of a sound in an audible range, the data may include data of a sound in an inaudible range.

As in FIG. 4, correct labels, indicating that the worker is performing a task in which a transparent bag is handled (also called a “bag task” hereinafter), have been added manually by the user visually confirming images. In the example in FIG. 5, a state in which a transparent bag is present on the workbench but the worker is not touching the transparent bag, and a state in which the worker is packing a product into a bag, have been assigned a correct label of “bag task”. On the other hand, a state in which the worker is making an entry on a document, is performing a task of unpacking an item, or the like is taken as not being a task in which a transparent bag is handled (i.e., a “non-bag task”).

In addition, the similarity of the feature of the image indicated in FIG. 5 indicates a similarity between (i) a feature indicating a transparent bag appearing in an image extracted using the image identification model and (ii) a feature indicating a transparent bag appearing in an image registered in advance.

As illustrated in FIG. 5, the similarity score increased when a sound other than a sound produced by a transparent bag occurred. In Verification Example 1, the accuracy of identifying tasks by the sound identification model had a 28% accuracy rate and a 5% error rate.

Although Verification Example 1 of Operation Example 1 describes an example in which first model 132 estimates a transparent object by calculating a similarity, and an example of a flow of those operations, the verification example is not limited thereto. For example, first model 132 may be a model that takes the data of a task sound as an input and directly estimates (i.e., outputs) whether the task is one in which a transparent object is handled. Another example of first model 132 and an example of the flow of operations thereof will be described hereinafter.

### Verification Example 2 of Operation Example 1

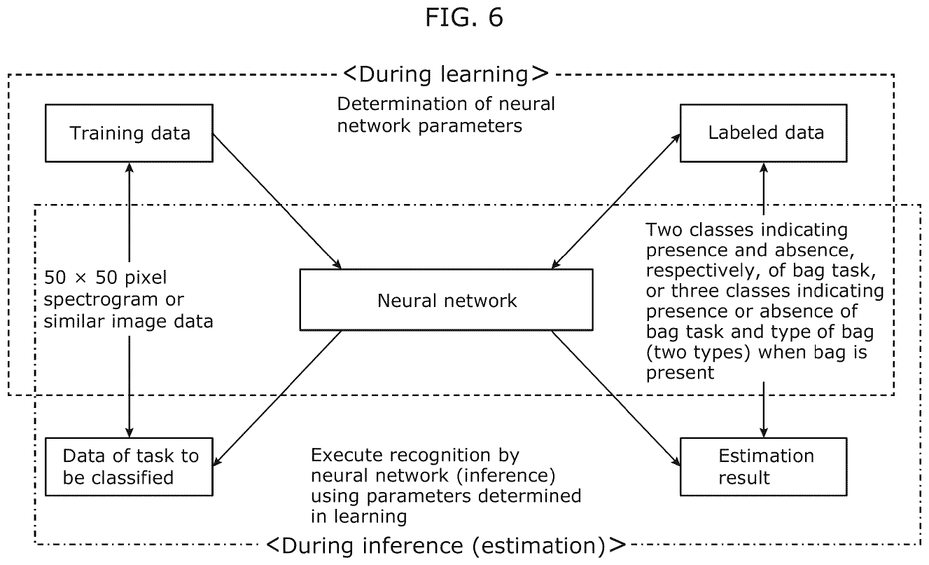

Verification Example 2 of Operation Example 1 will be described next. Verification Example 2 of Operation Example 1 describes an example in which first model 132 is model that takes data of a task sound as an input and directly outputs a result of estimating whether the task is one in which a transparent object is handled. FIG. 6 is a diagram illustrating a method for estimating a bag task performed in Verification Example 2. The neural network illustrated in FIG. 6 is an example of first model 132.

First, learning performed by the neural network used to estimate a bag task will be described.

Model generator 140 uses, as training data, images of spectrograms of task sounds or image data, in which the worker appears, that corresponds to task sounds (i.e., captured at the same time as the time a task sound was collected). Model generator 140 also uses, as labeled data, data in which the training data has been labeled with two classes indicating whether the worker is performing a bag task or not (i.e., the presence or absence of a bag task), or, three classes also indicating a type of the bag (e.g., a large bag, a small bag, or the like) when a bag task is present. Model generator 140 determines the parameters of the neural network through learning.

Next, estimator 122 performs inference through the neural network using the parameters determined during learning. For example, estimator 122 inputs the data for which a task is to be classified (the data of the task sound or the data of the image) into the neural network, and outputs a result of estimating the two classes of whether a bag task is present or the three classes of additionally classifying the type of the bag when a bag task is present.

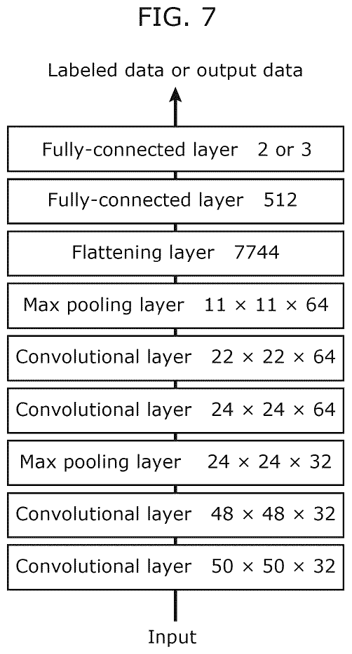

FIG. 7 is a diagram illustrating an example of the architecture of the neural network illustrated in FIG. 6. In the example in FIG. 7, the input data is images, and the neural network therefore includes convolutional layers. However, if, for example, the input data is time-series numerical data, the convolutional layers need not be included. Note that the example in FIG. 7 is merely an example, and the neural network is not limited to this example.

### Estimation of Two Classes

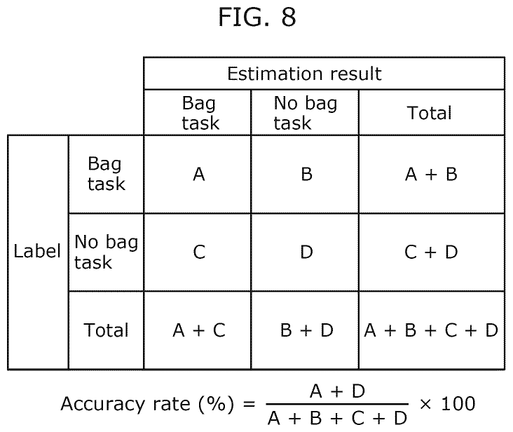

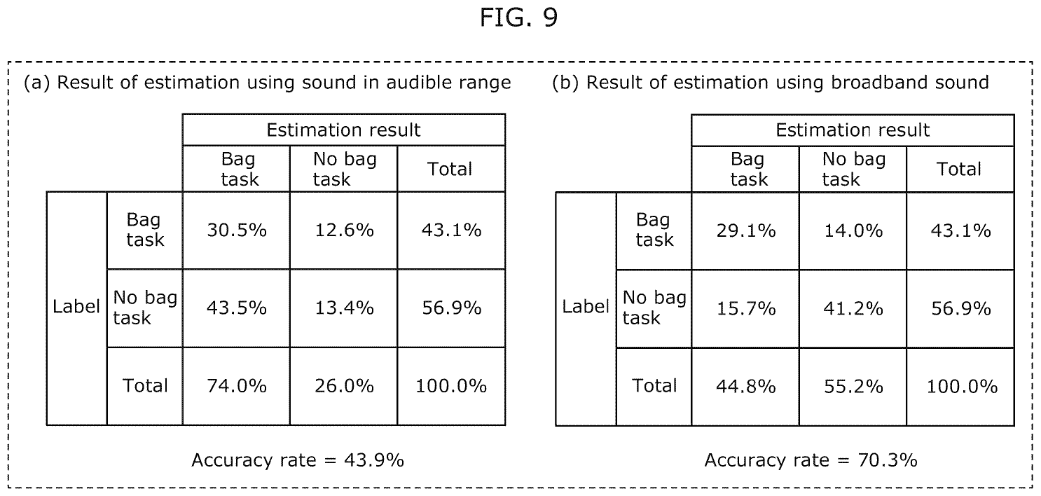

First, the estimation for the two classes, namely the presence or absence of a bag task, will be described. FIG. 8 is a diagram illustrating a method for calculating an accuracy rate when estimating two classes. The neural network was trained using data labeled as “bag task” or “no bag task” as the labeled data. The accuracy rate (%) was calculated using the formula illustrated in FIG. 8. FIG. 9 illustrates the estimation results and the accuracy rate.

FIG. 9 is a diagram illustrating estimation results and accuracy rates for two classes in Verification Example 2 of Operation Example 1. (a) in FIG. 9 indicates estimation results and an accuracy rate for two classes when data of a task sound input into the neural network is data of a sound in an audible range, and (b) in FIG. 9 indicates an estimation result and an accuracy rate for two classes when data of a task sound is data of a broadband sound including sound in an inaudible range. Bag task 1 is a task in which a polyethylene bag about 10 cm long and 10 cm wide is handled, and bag task 2 is a task in which a polyethylene bag about 30 cm long and 30 cm wide is handled. As indicated in (a) and (b) in FIG. 9, using data of a broadband task sound including sound in the inaudible range as the input data produced a higher accuracy rate than when using data of task sounds in an audible range. It was therefore confirmed that the task performed by the worker can be estimated more accurately when the data of the task sound is data of a broadband sound than data of sound in an audible range.

### Estimation of Three Classes

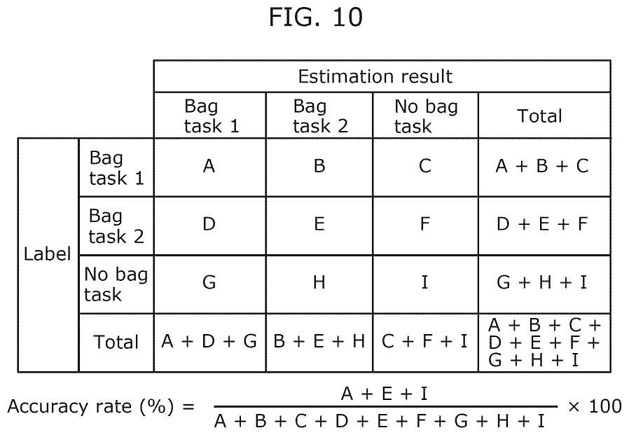

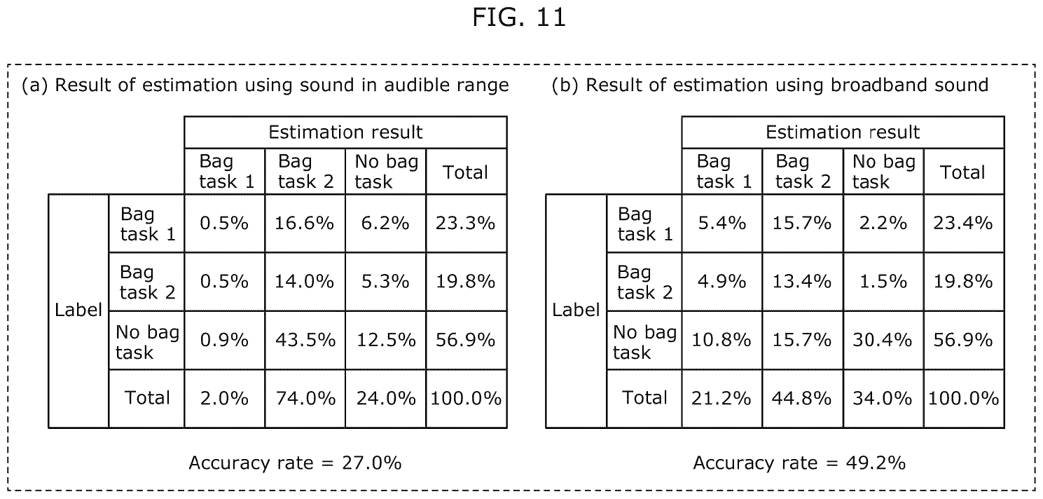

Next, the estimation for the two classes, namely when a bag task is present and the type of the bag is classified, will be described. FIG. 10 is a diagram illustrating a method for calculating an accuracy rate when estimating three classes. The neural network was trained using data labeled with the type of the bag task when there is a bag task, and “no bag task”, as the labeled data. The accuracy rate (%) was calculated using the formula illustrated in FIG. 10. FIG. 11 illustrates the estimation results and the accuracy rate.

FIG. 11 is a diagram illustrating estimation results and accuracy rates for three classes in Verification Example 2 of Operation Example 1. (a) in FIG. 11 indicates an estimation result and an accuracy rate for three classes when data of a task sound input into the neural network is data of a sound in an audible range, and (b) in FIG. 11 indicates an estimation result and an accuracy rate when data of a task sound is data of a broadband sound including sound in an inaudible range. As indicated in (a) and (b) in FIG. 11, using data of a broadband task sound including sound in the inaudible range as the input data produced a higher accuracy rate than when using data of task sounds in an audible range. It was therefore confirmed that the task performed by the worker can be estimated more accurately when the data of the task sound is data of a broadband sound than data of sound in an audible range.

### Estimation of Two Classes Using Combination of Input Data

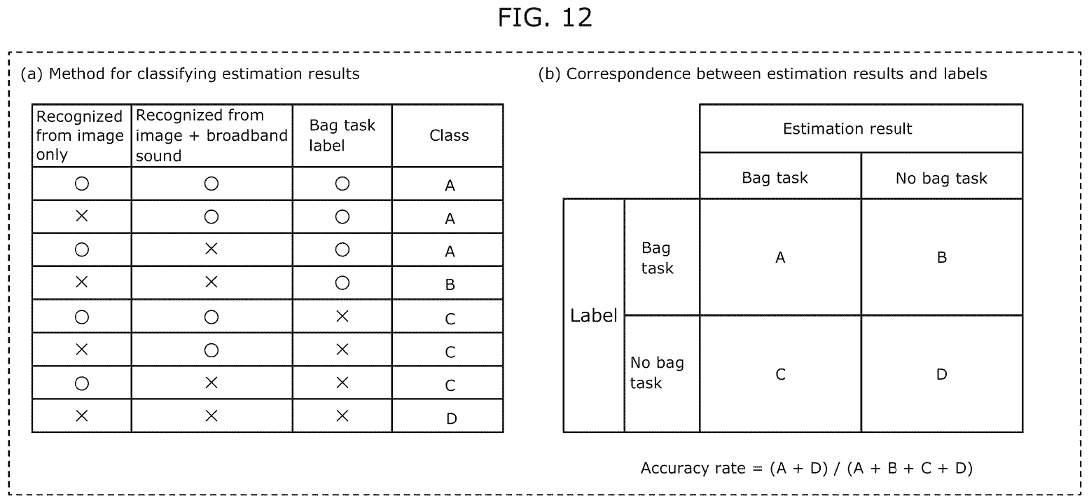

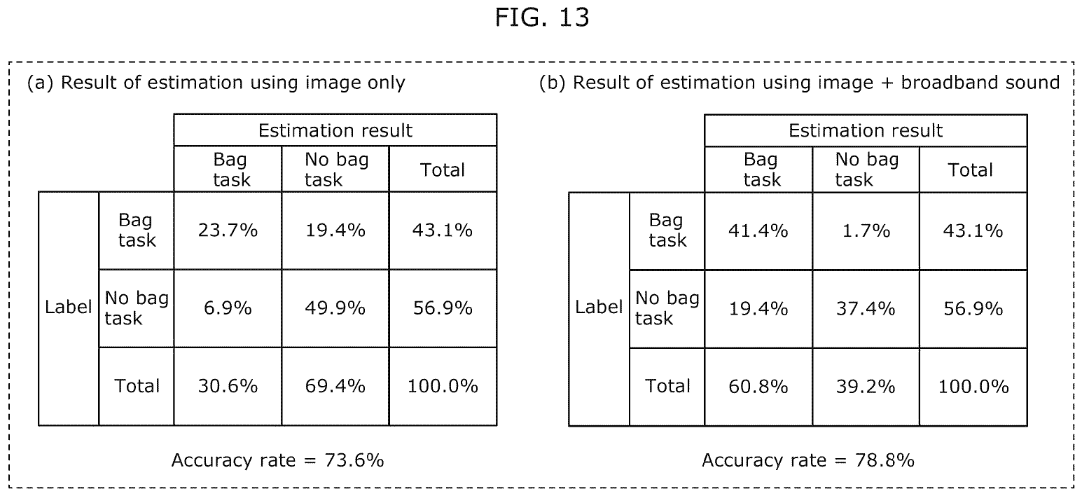

The estimation of two classes, namely whether a bag task is present or absent, using a combination of input data will be described next. FIG. 12 is a diagram illustrating a method for estimating two classes and a method for calculating an accuracy rate using a combination of input data. (a) in FIG. 12 indicates a method for classifying estimation results, and (b) in FIG. 12 indicates relationships between the estimation results and the labels. In (a) in FIG. 12, class A indicates that the task could be estimated as a bag task as per the label when the input data is at least one of (i) image data or (ii) data of an image+data of a broadband sound. class D indicates that the task could be estimated as no bag task as per the label when the input data is at least one of (i) or (ii) above. The accuracy rate (%) was calculated using the formula illustrated in (b) in FIG. 12. FIG. 13 illustrates the estimation results and the accuracy rate.

FIG. 13 is a diagram illustrating estimation results and accuracy rates of two classes using a combination of input data in Verification Example 2 of Operation Example 1. (a) in FIG. 13 indicates an estimation result and an accuracy rate for two classes when the input data input into the neural network is data of an image, and (b) in FIG. 13 indicates an estimation result and an accuracy rate when the input data is data of an image and data of a broadband task sound. As indicated in (a) and (b) in FIG. 13, using data of a broadband task sound as the input data resulted in a higher accuracy rate than when only data of an image was used. It was therefore confirmed that the task performed by the worker can be estimated more accurately when the input data input into the neural network is image data and data of a broadband task sound than when the input data is data of an image only.

### Verification Example 3 of Operation Example 1

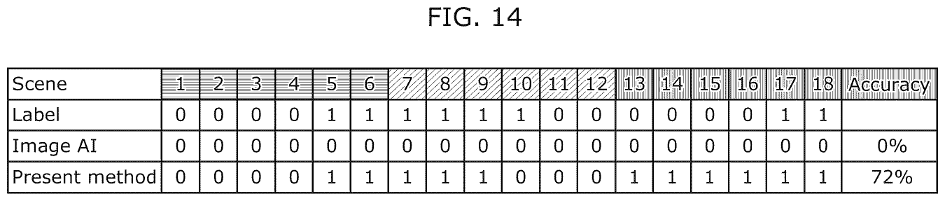

Verification Example 3 of Operation Example 1 will be described in detail next. Although Verification Example 1 used task sounds in an audible range for estimating tasks, Verification Example 3 differs from Verification Example 1 in that data of task sounds including sounds in an inaudible range were used. Furthermore, in Verification Example 3, the estimation accuracy when the estimation method described in Operation Example 1 was performed using data of a task sound including a sound in an inaudible range (called the “present method”) was compared with the estimation accuracy when an estimation method using image AI (i.e., video AI) was performed. Note that general image AI was used for the image AI. FIG. 14 illustrates the results.

FIG. 14 is a diagram illustrating a result of comparing the estimation accuracy of an estimation method using image AI and the present method. In FIG. 14, “1” in the label column indicates that a label indicating that a task in which a transparent bag is handled (i.e., a bag task) has been added (i.e., a correct label), and “0” indicates that a correct label has not been added (i.e., a non-bag task). In addition, “1” in the “image AI” and “present method” columns indicates that a bag task has been estimated as being performed, and “O” indicates that a bag task is estimated as not being performed. Here, whether “0” and “1” in the label column match the estimated results of the image AI and the present method was confirmed. The results were that the estimation accuracy of the image AI was 0%, and the estimation accuracy of the present method was 72%.

As a result of Verification Example 3, it was confirmed that estimating the task using data of a task sound including sound in an inaudible range improves the accuracy of estimating tasks in which a transparent object is handled, compared to when using data of sound in an audible range. It was also confirmed that using image AI (i.e., the image identification model) in conjunction with the sound identification model improves the accuracy of the estimation compared to when the task is estimated using image AI alone.

### Operation Example 2

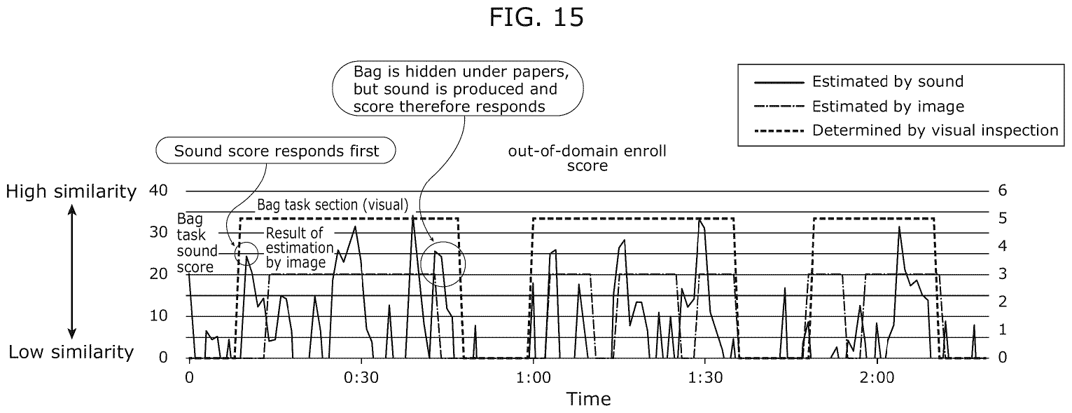

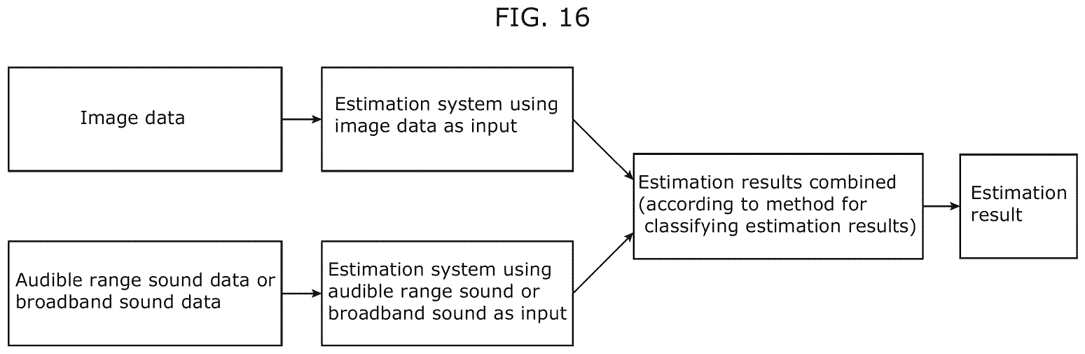

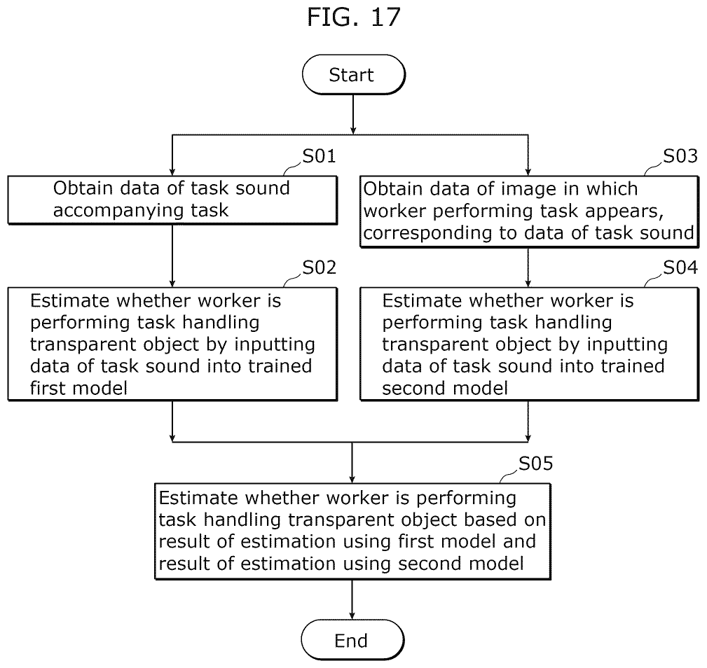

Operation Example 2 of estimation system 200 according to the embodiment will be described next with reference to FIGS. 15, 16, and 17. FIG. 15 is a diagram illustrating a difference between a result of estimation using data of a task sound and a result of estimation using data of an image. FIG. 16 is a diagram illustrating an overview of the flow of Operation Example 2 of estimation system 200 according to the embodiment. FIG. 17 is a flowchart illustrating Operation Example 2 of estimation system 200 according to the embodiment. Operation Example 2 will focus on points different from Operation Example 1, and descriptions of common steps will be omitted or simplified.

The findings leading to Operation Example 2 will be described first. For example, as illustrated in FIG. 15, a user visually confirmed the work of the worker in the images to determine the sections having bag tasks (the bag task sections), and confirmed the difference between the result of the visual determination, the result of estimating the bag tasks using task sounds (the similarity to a bag task sound in the task sound), and the result of estimating the bag tasks using images. The number of bag tasks can be counted even when only image data is used to estimate the tasks. However, the similarity score of the sound responded (increased) before the estimation performed using images, for example. Additionally, for example, although a bag task could not be estimated even using image data when the bag was hidden under papers or the like and did not appear in the image, the similarity score of the sound responded (increased) due to the sound produced when the transparent bag was handled (the transparent bag sound).

In this manner, when estimating a bag task using images, if the transparent bag does not appear in the images, there are situations where the worker is not estimated to be performing a bag task. Accordingly, estimating bag tasks using a combination of estimating bag tasks using images and estimating bag tasks using task sounds makes it possible to estimate bag tasks with greater accuracy.

An overview of the flow of Operation Example 2 will be described next. For example, as illustrated in FIG. 16, in Operation Example 2, when obtainer 121 of estimation device 100 obtains the data of an image corresponding to the data of a task sound, the data of the image is input to estimation system 200, which takes the data of the image as an input. For example, estimation system 200 performs pre-processing such as adjusting the size of the input image data, normalization, or the like, as indicated in FIG. 3, and calculates a similarity to a feature indicating a transparent bag appearing in an image based on a feature of an image output after input to the neural network (e.g., the image identification model). Additionally, in Operation Example 2, upon obtaining data of the task sound, obtainer 121 of estimation device 100 inputs the data of the task sound to estimation system 200, which takes the data of the task sound as an input. For example, the system performs pre-processing such as normalizing the input data of the task sound, as indicated in FIG. 3, and calculates a similarity to a feature of a bag task sound based on a feature of a task sound output after input to the neural network (e.g., the sound identification model). An estimation result is then output by combining the results of the estimations performed by estimation system 200.

Operation Example 2 will be described next with reference to FIG. 17. Although not illustrated in FIG. 17, sound collection device 10 collects a task sound accompanying a task performed by a worker, and outputs data of the collected task sound to estimation device 100. Additionally, image capturing device 20 captures an image in which the worker performing the task appears, corresponding to the task sound collected by sound collection device 10 (i.e., captured at the same time), and outputs data of the captured image to estimation device 100. Note that when the worker is performing a task in which a transparent object is handled, the transparent object (here, a transparent bag) appears in the image along with the worker.

Next, upon obtaining the data of a task sound that accompanies the task performed by the worker (S01), obtainer 121 of estimation device 100 outputs the obtained data of the task sound to estimator 122. Next, estimator 122 estimates whether the worker is performing a task in which a transparent object is handled by inputting the data of the task sound into first model 132 (S02). More specifically, for example, when a similarity between the feature extracted by first model 132 and a feature of a task sound of a task in which a transparent object is handled, stored in storage 130 in advance, is at least a predetermined value (i.e., a threshold), estimator 122 estimates that the worker is performing a task in which a transparent object is handled.

Additionally, upon obtaining data of an image in which the worker performing the task appears, corresponding to the data of the task sound (S03), obtainer 121 of estimation device 100 outputs the obtained data of the image to estimator 122. Next, estimator 122 estimates whether the worker is performing a task in which a transparent object is handled by inputting the data of the image into second model 133 (S04). Specifically, for example, when a similarity between the feature of the image, extracted by second model 133, in which the worker performing a task in which a transparent object is handled appears, and a feature of an image in which a worker handling a transparent object, stored in storage 130 in advance, appears is at least a predetermined value (i.e., a threshold), estimator 122 estimates that the worker is performing a task in which a transparent object is handled.

Next, estimator 122 estimates whether the worker is performing a task in which a transparent object is handled based on the estimation result estimated from the data of the task sound using first model 132 and the estimation result estimated from the data of the image using second model 133 (S05). Specifically, for example, when (i) the similarity between the feature of the task sound extracted by first model 132 and the feature of the task sound of a task in which a transparent object is handled, stored in storage 130 in advance, is at least the predetermined value (the threshold), and (ii) the similarity between the feature of the image extracted by second model 133 and the feature of the image in which the worker handling a transparent object, stored in storage 130 in advance, appears is at least the predetermined value (the threshold), estimator 122 estimates that the worker is performing a task in which a transparent object is handled.

### Variation 1 on Operation Example 2

Operation Example 2 described an example in which whether the worker is performing a task in which a transparent object is handled is estimated based on a feature obtained by inputting data of a task sound into first model 132 and a feature obtained by inputting data of an image into second model 133. In Variation 1 on Operation Example 2, whether a worker is performing a task in which a transparent object is handled is estimated based on a feature of a task sound and a feature of an image obtained by inputting data of a task sound and data of an image into first model 132, according to the example of first model 132 described in Verification Example 2 of Operation Example 1, which directly estimated whether a task is one in which a transparent object is handled.

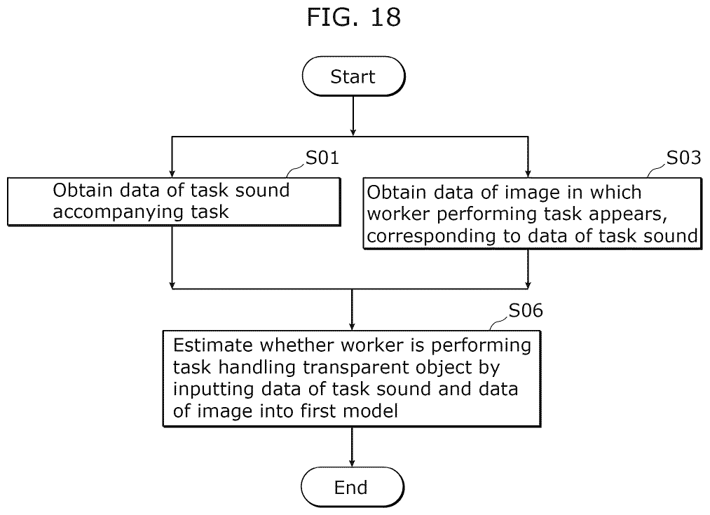

FIG. 18 is a flowchart illustrating Variation 1 on Operation Example 2 of estimation system 200 according to the embodiment. As illustrated in FIG. 18, obtainer 121 of estimation device 100 obtains the data of the task sound collected by sound collection device 10 (S01), and outputs the obtained data to estimator 122. Additionally, obtainer 121 of estimation device 100 obtains data of an image in which the worker performing the task appears, captured by image capturing device 20 and corresponding to the data of the task sound (S03), and outputs the obtained data to estimator 122.

Next, estimator 122 estimates whether the worker is performing a task in which a transparent object is handled based on a feature of a task sound and a feature of an image obtained by inputting the data of the task sound and the data of the image into first model 132 (S06).

### Configuration Example 1 of Estimator 122 That Performs Flow of Variation 1 on Operation Example 2

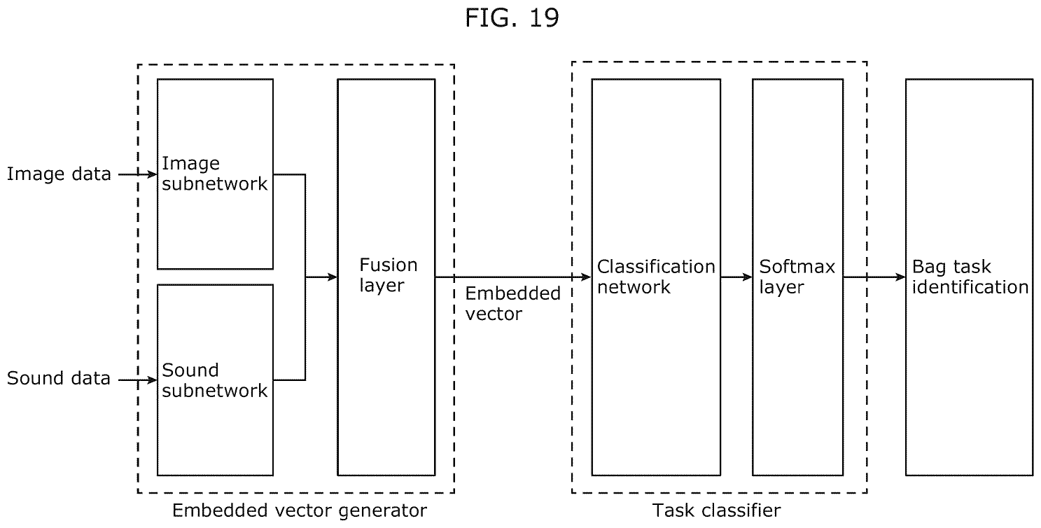

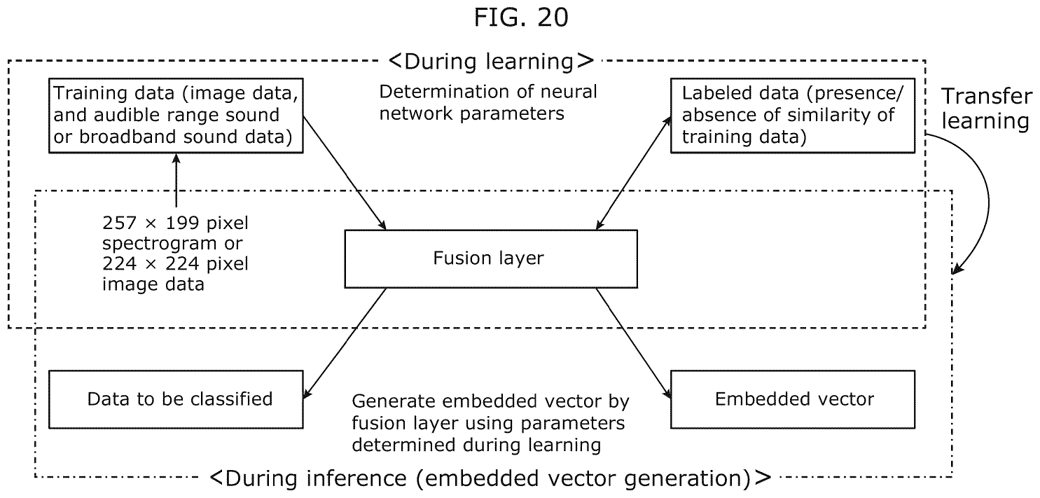

Configuration Example 1 of estimator 122 that performs the flow of Variation 1 on Operation Example 2 will be described next. FIG. 19 is a diagram schematically illustrating Configuration Example 1 of estimator 122 that performs the flow of Variation 1 on Operation Example 2. FIG. 20 is a diagram illustrating a method for estimating a bag task performed by Configuration Example 1.

As illustrated in FIG. 19, estimator 122 includes an embedded vector generator, a task classifier, and a bag task identifier. The embedded vector generator includes an image subnetwork that takes data of an image as an input and extracts a feature of the image, a sound subnetwork that takes data of a sound (here, a task sound) as an input and extracts a sound feature (here, a feature of the task sound), and a fusion layer.

As illustrated in FIG. 19, the neural network may include an image subnetwork and a sound subnetwork, for example. Such a neural network may serve as first model 132. Additionally, the sound subnetwork may serve as first model 132, and the image subnetwork may serve as second model 133.

As illustrated in FIG. 20, model generator 140 uses the data of the image and the data of the task sound as training data, and uses data labeled with the presence or absence of a similarity to the training data as labeled data. Model generator 140 determines the parameters of the neural network through learning. The data of the task sound is data of a broadband sound including sound in an audible range or sound in an inaudible range. The data of the task sound may be a spectrogram having 257×199 pixels, for example. The data of the image may be data having 224×224 pixels, for example. Note that model generator 140 may perform transfer learning in the fusion layer.

Next, estimator 122 generates an embedded vector by the fusion layer using the parameters determined during learning. Then, estimator 122 inputs the embedded vector to the task classifier, and identifies a bag task based on a probability value output from a Softmax layer.

### Configuration Example 2 of Estimator 122 That Performs Flow of Variation 1 on Operation Example 2

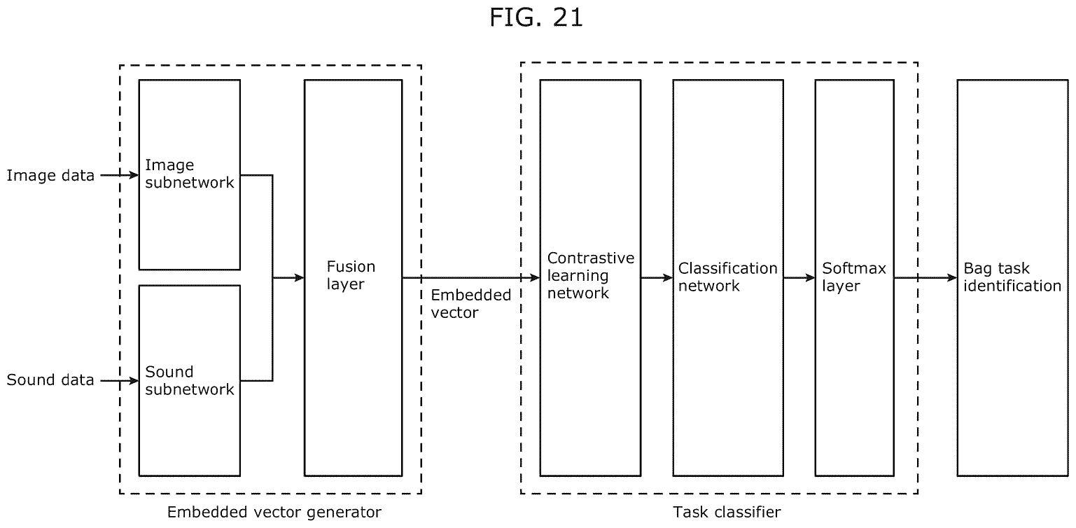

Configuration Example 2 of estimator 122 that performs the flow of Variation 1 on Operation Example 2 will be described next. FIG. 21 is a diagram schematically illustrating Configuration Example 2 of estimator 122 that performs the flow of Variation 1 on Operation Example 2. In Configuration Example 1, the task classifier included a classification network and a Softmax layer, but in Configuration Example 2, the task classifier includes a contrastive learning network. Contrastive learning is a type of self-taught learning in which a large amount of data can be learned by using a system that compares data, without any labeling. In contrastive learning, features are learned such that similar data are close and different data are distant.

### Configuration Example 3 of Estimator 122 That Performs Flow of Variation 1 on Operation Example 2

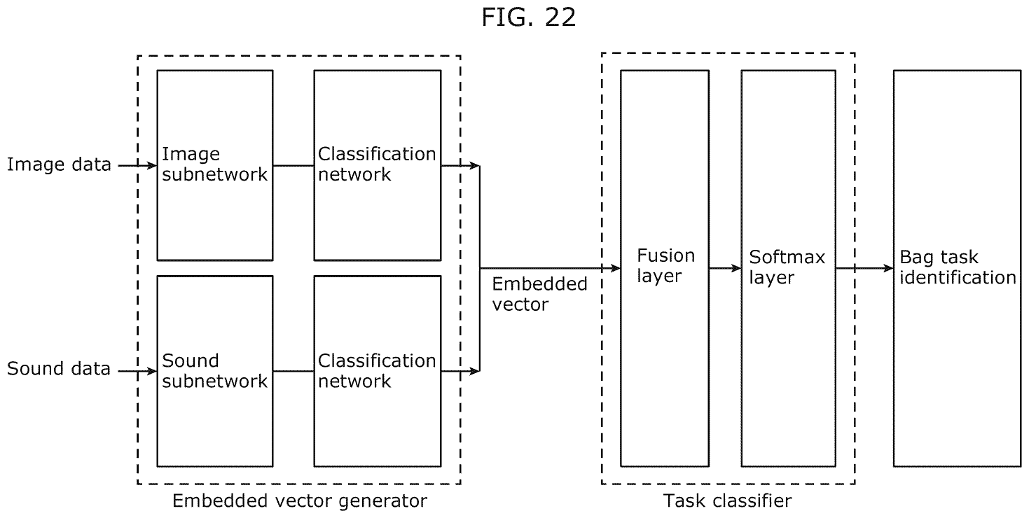

Configuration Example 3 of estimator 122 that performs the flow of Variation 1 on Operation Example 2 will be described next. FIG. 22 is a diagram schematically illustrating Configuration Example 3 of estimator 122 that performs the flow of Variation 1 on Operation Example 2. In Configuration Example 1 and Configuration Example 2, the fusion layer was located before the classification network, but in Configuration Example 3, the fusion layer is located after the classification network.

### Examples of Architecture of Image Subnetwork and Sound Subnetwork

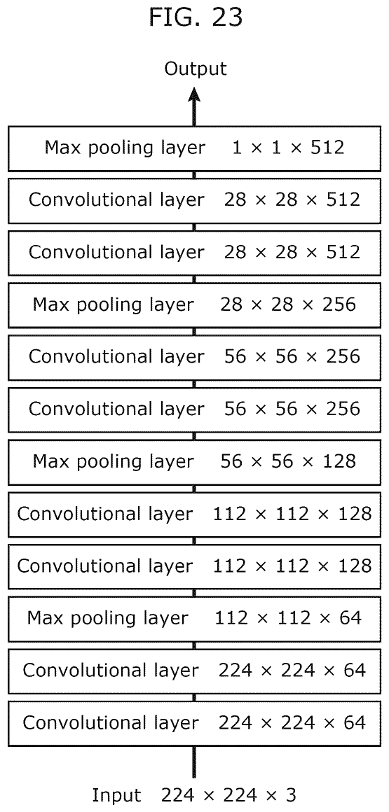

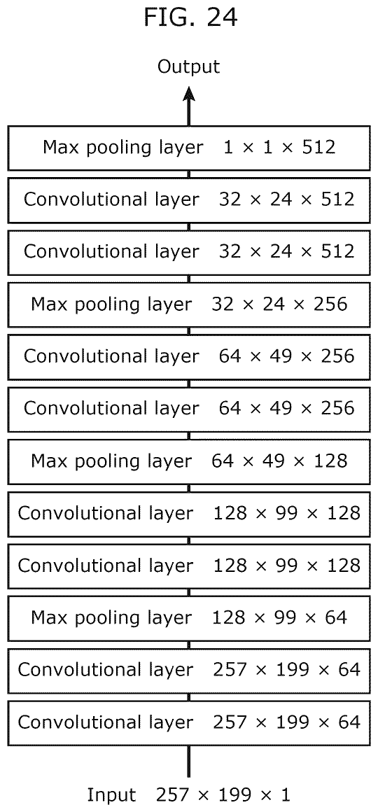

Examples of the architecture of the image subnetwork and the sound subnetwork will be described next. FIG. 23 is a diagram illustrating an example of the architecture of the image subnetwork. FIG. 24 is a diagram illustrating an example of the architecture of the sound subnetwork. As illustrated in FIGS. 23 and 24, the data of images and the data of task sounds serving as the input data often have different sizes, and thus the sizes of each of the layers in the image subnetwork and the sound subnetwork need not be identical; it is sufficient for the final layers of the subnetworks to be the same size.

### Example of Architecture of Fusion Layer

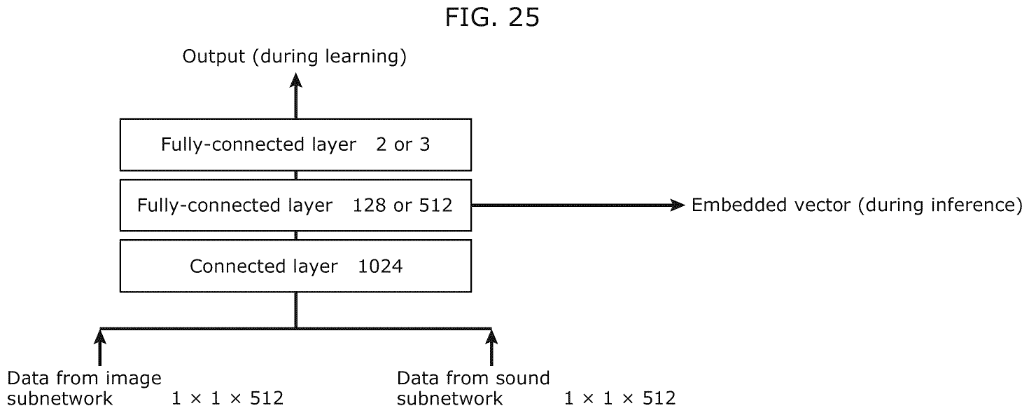

FIG. 25 is a diagram illustrating an example of the architecture of the fusion layer. As illustrated in FIG. 25, the data output from the image subnetwork and the data output from the sound subnetwork are input to a connected layer, and different outputs are obtained during learning and during inference.

### Example of Architecture of Classification Network

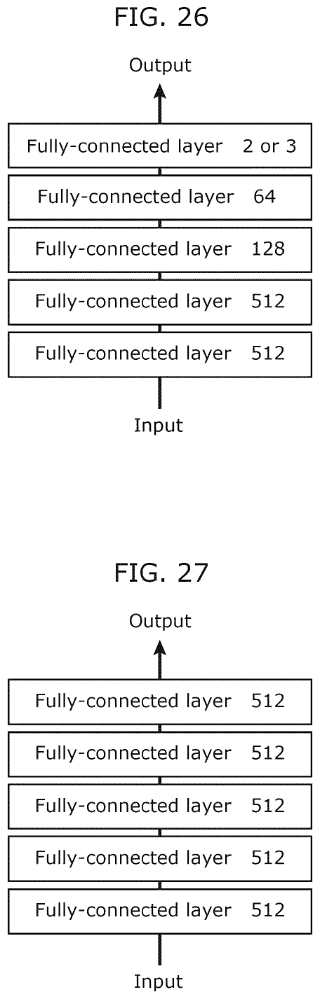

FIG. 26 is a diagram illustrating an example of the architecture of the classification network. As illustrated in FIG. 26, for example, when located after the image subnetwork, the size of the first layer of the classification network is the same size as the data output from the final layer of the image subnetwork, and when located after the sound subnetwork, the size of the first layer of the classification network is the same size as the data output from the final layer of the sound subnetwork. Additionally, for example, when the classification network is located after the fusion layer, the size of the first layer of the classification network is the same size as the data output from the final layer of the fusion layer.

### Example of Architecture of Contrastive Learning Network

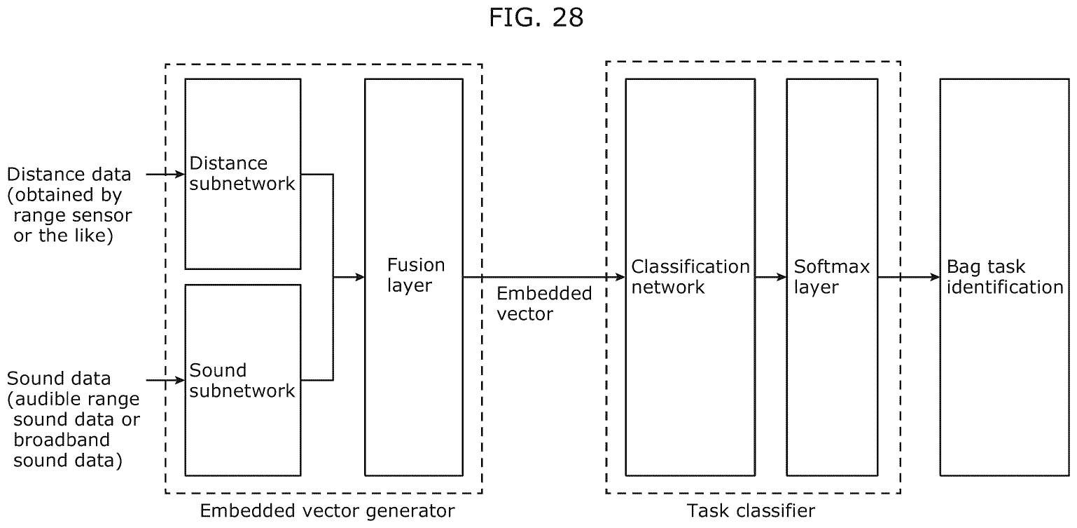

FIG. 27 is a diagram illustrating an example of the architecture of the contrastive learning network. As illustrated in FIG. 27, the size of the first layer of the contrastive learning network is, for example, the same as the size of the embedded vector output from the embedded vector generator. A contrastive learning network is used as transfer learning. However, for example, the following Formula 1 is used as the loss function.

$$\begin{matrix}[ Math 1 ] & \\ {I}_{i , j} = - log \frac{exp ( s i m ( {z}_{i} , {z}_{k} ) / T )}{{\sum }_{k = 1}^{2 N} {1}_{k \neq i} exp ( s i m ( {z}_{i} , {z}_{k} ) / T )} & Formula ( 1 )\end{matrix}$$

Here, sim (x, y) is a function that calculates a similarity, and for example, a cosine similarity may be used. zi and zj are corresponding embedded vectors, and for example, embedded vectors of data of an image and data of a broadband task sound, respectively, may be used. T is an adjustment parameter.

The loss function of Formula 1 above is greater when the similarity of the two embedded vectors is high, and lower when the similarity is low.

### Configuration Example of Estimator 122 That Performs Flow of Variation 2 on Operation Example 2

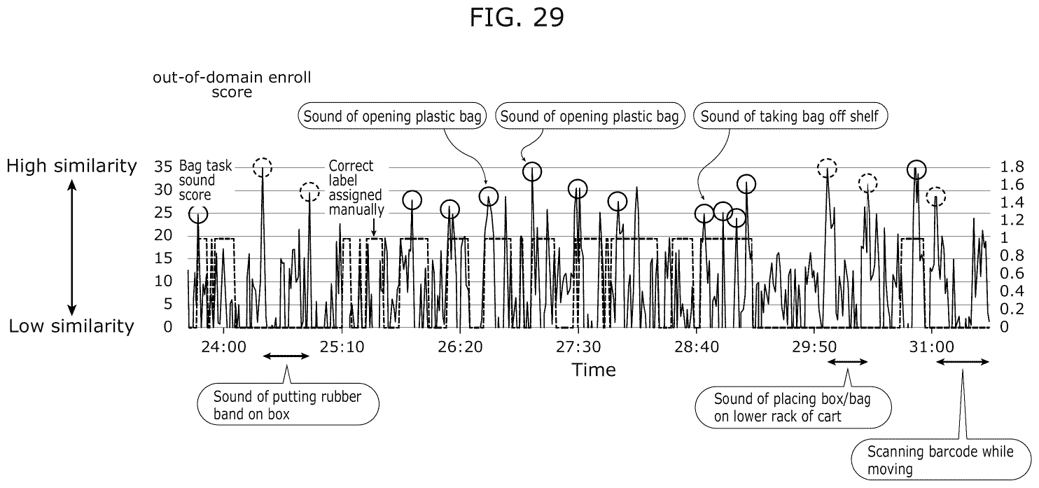

FIG. 28 is a diagram schematically illustrating a configuration example of estimator 122 that performs the flow of Variation 2 on Operation Example 2. The flow of Variation 2 on Operation Example 2 will be described with reference to the flow of Variation 1 on Operation Example 2 illustrated in FIG. 18. In Variation 1 on Operation Example 2, the data of an image was obtained and used as the input data, but in Variation 2 on Operation Example 2, distance data obtained by a range sensor or the like may be used as the input data instead of the data of an image captured by image capturing device 20 in step S03 of FIG. 18. In this case, as illustrated in FIG. 28, estimator 122 includes a distance subnetwork instead of the image subnetwork. Note that the configuration example is not limited to the example in FIG. 28, and for example, in another configuration example, the location of the fusion layer may be changed as in Configuration Example 2 or Configuration Example 3 of Variation 1 on Operation Example 2, or the task classifier may include a contrastive learning network.

### Operation Example 3

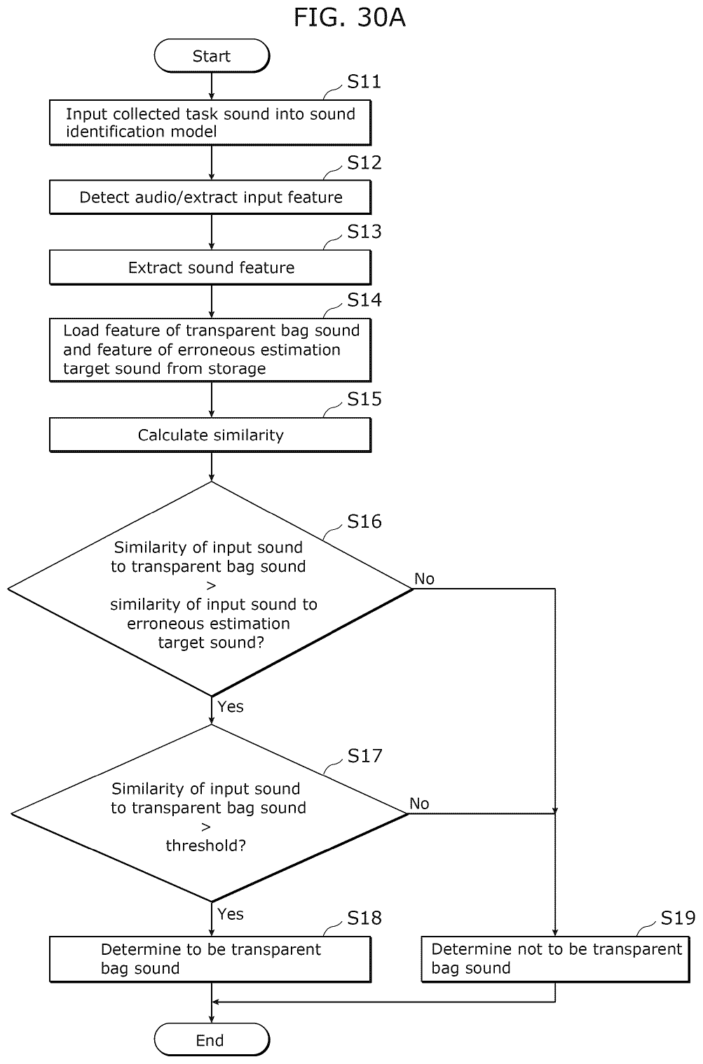

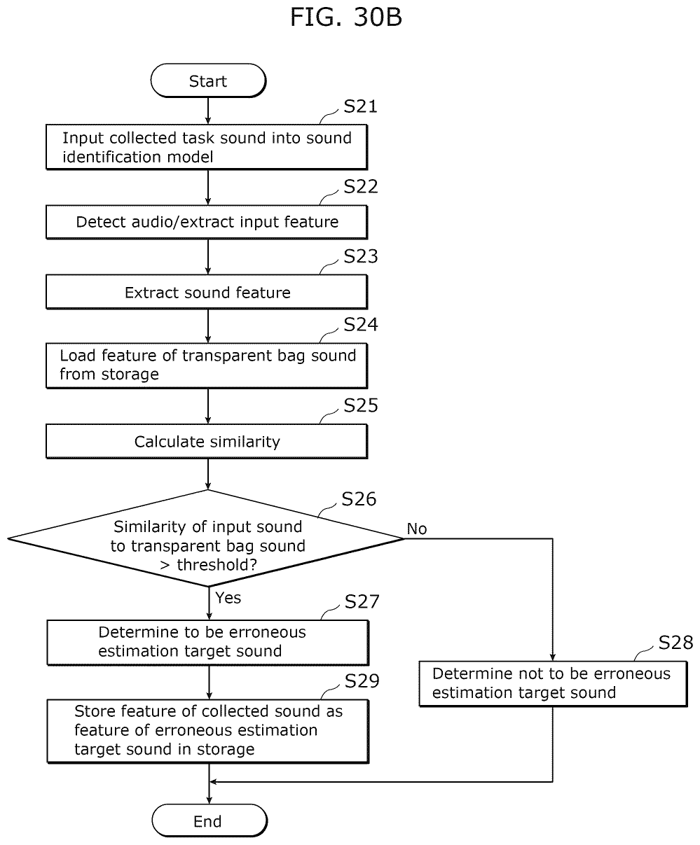

Operation Example 3 of estimation system 200 according to the embodiment will be described next with reference to FIGS. 29, 30A, and 30B. FIG. 29 is a diagram illustrating an example of a task sound when a worker is erroneously estimated by estimator 122 to be performing a task in which a transparent object is handled. FIG. 30A is a flowchart illustrating Operation Example 3 of estimation system 200 according to the embodiment. FIG. 30B is a flowchart illustrating an example of operations for pre-registering features of task sounds that can be erroneously estimated.

In Operation Example 3, a task sound that accompanies a task in which a transparent bag is handled will be called a “transparent bag sound”, and a task sound that accompanies a task in which a non-transparent bag is handled (i.e., a transparent bag is not handled) will be called a “non-transparent bag sound”. A task in which a transparent bag is handled will be called a “bag task”.

First, a task sound that can be erroneously estimated (also called an “erroneous estimation target sound”) will be described hereinafter with reference to FIG. 29. In the example in FIG. 29, the similarity threshold is, for example, 25, and estimator 122 estimates that the worker is performing a task in which a transparent bag is handled (a bag task) when the similarity of the task sound to the transparent bag sound is at least the threshold. At this time, although there are situations where the task performed by the worker is accurately estimated based on the task sound accompanying the task in which a transparent bag is handled, such as the sound of opening a plastic bag, the sound of taking a bag off of a shelf, and the like, there are also situations where a bag task is erroneously estimated to be being performed despite the worker not performing a bag task. For example, a worker may be erroneously estimated to be performing a bag task based on a task sound other than a transparent bag sound (i.e., a non-transparent bag sound), such as the sound of putting a rubber band on a box, the sound of placing a box or a bag on the lower rack of a cart, the sound of scanning a barcode while moving, or the like.

In order to reduce such erroneous estimations, estimator 122 calculates a similarity between a feature of a non-transparent bag sound and a feature of a transparent bag sound registered in advance, and when the similarity exceeds a threshold, determines that the non-transparent bag sound is an erroneous estimation target sound, and stores that sound in storage 130. In Operation Example 3, estimator 122 loads a feature of a task sound that can be erroneously estimated, registered in advance (also called an “erroneous estimation target sound” hereinafter), and a feature of a transparent bag sound, from storage 130, compares the similarity between the feature of the task sound and the stated features, and estimates whether the worker is performing a bag task.

Operation Example 3 will be described next with reference to FIG. 30A. Although not illustrated, obtainer 121 of estimation device 100 obtains the data of the task sound collected by sound collection device 10, and outputs the obtained data to estimator 122.

Estimator 122 inputs the obtained data of the task sound into the sound identification model (S11), detects audio from the input data of the task sound, and extracts an input feature (S12).

Next, estimator 122 extracts a feature (a sound feature) of the task sound (called in “input sound” hereinafter) using the sound identification model (S13). Next, estimator 122 loads the feature of the transparent bag sound and the feature of the erroneous estimation target sound from storage 130 (S14).

Next, in calculating the similarity (S15), estimator 122 calculates a similarity between the transparent bag sound and the input sound, and a similarity between the erroneous estimation target sound and the input sound.

Next, estimator 122 determines whether the similarity between the transparent bag sound and the input sound is higher than the similarity between the erroneous estimation target sound and the input sound (S16), and when the similarity is determined to be higher (Yes in S16), determines whether the similarity between the transparent bag sound and the input sound is higher than a threshold (S17). If the similarity between the transparent bag sound and the input sound is determined to be higher than the threshold (Yes in S17), estimator 122 determines that the input sound is a transparent bag sound (S18). Through this, estimator 122 estimates that the worker is performing a task in which a transparent bag is handled based on the feature of the input sound (the task sound).

On the other hand, if the similarity between the transparent bag sound and the input sound is determined not to be higher than the similarity between the erroneous estimation target sound and the input sound in step S16 (No in S16), estimator 122 determines that the input sound is not a transparent bag sound (S19). Additionally, if the similarity between the transparent bag sound and the input sound is determined not to be higher than the threshold in step S17 (No in S17), estimator 122 determines that the input sound is not a transparent bag sound (S19). Through this, estimator 122 estimates that the worker is performing a task in which a transparent bag is not handled based on the feature of the input sound (the task sound).

An example of operations in which the feature of the erroneous estimation target sound used in Operation Example 3 is stored in storage 130 in advance will be described next with reference to FIG. 30B. Although not illustrated, obtainer 121 of estimation device 100 obtains the data of the task sound obtained by sound collection device 10, and outputs the obtained data to estimator 122. At this time, the data of the task sound obtained by obtainer 121 is a task sound that accompanies a task in which a transparent bag is not handled.

Estimator 122 inputs the obtained data of the task sound into the sound identification model (S21), detects audio from the input data of the task sound, and extracts an input feature (S22).

Next, estimator 122 extracts a feature (a sound feature) of the task sound (called in “input sound” hereinafter) using the sound identification model (S23). Next, estimator 122 loads the feature of the transparent bag sound from storage 130 (S24).

Next, in calculating the similarity (S25), estimator 122 calculates a similarity between the transparent bag sound and the input sound.

Next, estimator 122 determines whether the similarity between the transparent bag sound and the input sound is higher than a threshold (S26), and if the similarity is determined to be higher than the threshold (Yes, in S26), determines that the input sound is an erroneous estimation target sound (S27). Estimator 122 then stores the feature of the collected sound (the task sound) as a feature of the erroneous estimation target sound in storage 130 (S29). On the other hand, if the similarity between the transparent bag sound and the input sound is determined not to be higher than the threshold (No in S26), estimator 122 determines that the input sound is not an erroneous estimation target sound (S28).

### 4. Effects, Etc

As described above, an estimation method according to the present embodiment is an estimation method, performed by a computer (e.g., estimation device 100), of estimating a task performed by a worker. The estimation method includes: obtaining data of a task sound that accompanies the task and that has been collected (S01 in FIG. 2); and estimating whether the worker is performing a task in which a transparent object is handled, by inputting the data of the task sound into first model 132 that has been trained (S02 in FIG. 2).

Through this, the device that performs the estimation method (e.g., estimation device 100) uses first model 132, which takes the data of the task sound as an input and outputs whether the task is one in which a transparent object is handled, which makes it possible to accurately estimate tasks in which a transparent object is handled.

For example, the estimation method according to the present embodiment further includes the computer (e.g., estimation device 100): obtaining data of an image in which the worker performing the task appears, the data of the image corresponding to the data of the task sound (S03 in FIG. 17); estimating whether the worker is performing the task in which the transparent object is handled, by inputting the data of the image into second model 133 that has been trained (S04 in FIG. 17); and estimating whether the worker is performing the task in which the transparent object is handled, based on a result of the estimating using first model 132 and a result of the estimating using second model 133 (S05 in FIG. 17). Note that the estimation result using first model 132 is an estimation result estimated from the data of the task sound by first model 132, and the estimation result using second model 133 is an estimation result estimated from the data of the image by second model 133.

Through this, the device that performs the estimation method (e.g., estimation device 100) estimates whether the worker is performing a task in which a transparent object is handled based on the estimation result estimated from the data of the task sound by first model 132 and the estimation result estimated from the data of the image by second model 133. Accordingly, the device that performs the estimation method can estimate tasks in which a transparent object is handled more accurately than when estimating using only the data of the task sound.

For example, the estimation method according to the present embodiment further includes the computer (e.g., estimation device 100): obtaining data of an image in which the worker performing the task appears, the data of the image corresponding to the data of the task sound (S03 in FIG. 18); and estimating whether the worker is performing the task in which the transparent object is handled, by inputting the data of the task sound and the data of the image into first model 132 (S06).

Through this, the device that performs the estimation method (e.g., estimation device 100) uses first model 132, which takes the data of the task sound and the data of an image corresponding to the task sound as an input and outputs whether the task is one in which a transparent object is handled, which makes it possible to estimate tasks in which a transparent object is handled more accurately than when estimating using only the data of the task sound.

For example, the estimation method according to the present embodiment further includes the computer (e.g., estimation device 100): estimating whether the worker is performing the task in which the transparent object is handled, based on a similarity between a feature of the task sound output from first model 132 and a feature, stored in storage 130 (e.g., feature database 131 in FIG. 1) in advance, of a task sound of the task in which the transparent object is handled.

Through this, the device that performs the estimation method (e.g., estimation device 100) estimates whether the worker is performing a task in which a transparent object is handled based on the similarity between the feature of the task sound output from first model 132 and the feature of the task sound of a task in which a transparent object is handled, which makes it possible to accurately estimate tasks in which a transparent object is handled.

For example, the estimation method according to the present embodiment further includes the computer (e.g., estimation device 100): estimating whether the worker is performing the task in which the transparent object is handled, based on each of (i) a similarity a feature of a task sound, stored in advance in storage 130 (e.g., feature database 131), of the task in which the transparent object is handled (i.e., the first similarity), and (ii) a similarity of a feature of a task sound, stored in advance in storage 130 (e.g., feature database 131), from which the worker can be erroneously estimated to be performing the task in which the transparent object is handled (e.g., the erroneous estimation target sound in FIG. 30A) (i.e., the second similarity), to a feature of the task sound output from the first model 132 (S16 to S19 in FIG. 30A).

Through this, the device that performs the estimation method (e.g., estimation device 100) can reduce the occurrence of erroneous estimations by comparing the similarity between the feature of a task sound output from first model 132 and a feature of a task sound of a task in which a transparent object is handled (a first similarity) with a similarity between the feature of the task sound output from first model 132 and a feature of a task sound that can be erroneously estimated (a second similarity). Accordingly, the device that performs the estimation method can accurately estimate tasks in which a transparent object is handled even when using only the data of the task sound.

For example, in the estimation method according to the present embodiment, the computer (e.g., estimation device 100) estimates the worker is performing the task in which the transparent object is handled when the similarity of the feature of the task sound output from first model 132 to the feature of the task sound of the task in which the transparent object is handled (the first similarity) exceeds the similarity to the feature of the task sound from which the worker can be erroneously estimated to be performing the task in which the transparent object is handled (the erroneous estimation target sound in FIG. 30A) (the second similarity) (Yes in S16 in FIG. 30A).

Through this, the device that performs the estimation method (e.g., estimation device 100) can reduce the occurrence of erroneous estimations, which makes it possible to accurately estimate tasks in which a transparent object is handled even when only the data of the task sound is used.

For example, the estimation method according to the present embodiment further includes the computer (estimation device 100): when a similarity of (i) a feature of a task sound of a task in which a non-transparent object different from the transparent object is handled, the feature being obtained by inputting, to first model 132, data of the task sound of the task in which the non-transparent object is handled, to (ii) the feature of the task sound of the task in which the transparent object is handled (i.e., the third similarity), exceeds a threshold (Yes in S26 in FIG. 30B), determining that the task sound of the task in which the non-transparent object is handled is a task sound that can be erroneously estimated as a task sound of the task in which the transparent object is handled (the erroneous estimation target sound) (S27 in FIG. 30B); and storing, in storage 130 (e.g., feature database 131), the feature of the task sound of the task in which the non-transparent object is handled as the feature of the task sound that can be erroneously estimated (S29 in FIG. 30B).

Through this, based on a similarity between the feature of a task sound of a task in which a non-transparent object is handled and the feature of a task sound of a task in which a transparent object is handled (a third similarity), the device that performs the estimation method (e.g., estimation device 100) can accurately determine whether the task sound of the task in which the non-transparent object is handled is a task sound that can be erroneously estimated as being a task sound of a task in which the transparent object is handled. Accordingly, the device that performs the estimation method can store the features of task sounds which are relatively likely to be erroneously estimated in storage 130. As such, the device that performs the estimation method can reduce the occurrence of erroneous estimations by using the feature of a task sound that can be erroneously estimated, stored in storage 130, which makes it possible to accurately estimate tasks in which a transparent object is handled even when only the data of the task sound is used.

In the estimation method according to the present embodiment, the data of the task sound may include data of a sound in an inaudible range.

Through this, the device that performs the estimation method (e.g., estimation device 100) estimates whether the worker is performing a task in which a transparent object is handled using the data of a task sound including sound from an audible range to an inaudible range. Including sound in an inaudible range in the data of the task sound ensures the data of the task sound contains less environmental noise, which can cause erroneous estimations, and thus the device that performs the estimation method can increase the accuracy of estimating tasks in which a transparent object is handled. Furthermore, the device that performs the estimation method can estimate whether the worker is performing a task in which a transparent object is handled based on more information than when using only data of sound in an audible range. Accordingly, the device that performs the estimation method can more accurately estimate tasks in which a transparent object is handled.

Estimation device 100 according to the present embodiment is an estimation device that estimates a task performed by a worker, and includes: obtainer 121 that obtains data of a task sound that accompanies the task and that has been collected; and estimator 122 that estimates whether the worker is performing a task in which a transparent object is handled by inputting the data of the task sound into first model 132 that has been trained.

Through this, estimation device 100 uses first model 132, which takes the data of the task sound as an input and outputs whether the task is one in which a transparent object is handled, which makes it possible to accurately estimate tasks in which a transparent object is handled.

Additionally, a program according to the present embodiment is a program that causes a computer to execute the above-described estimation method.

Accordingly, the same effects as those of the above-described estimation method can be achieved using a computer.

### Other Embodiments

Although an embodiment has been described thus far, the present disclosure is not limited to the foregoing embodiment.

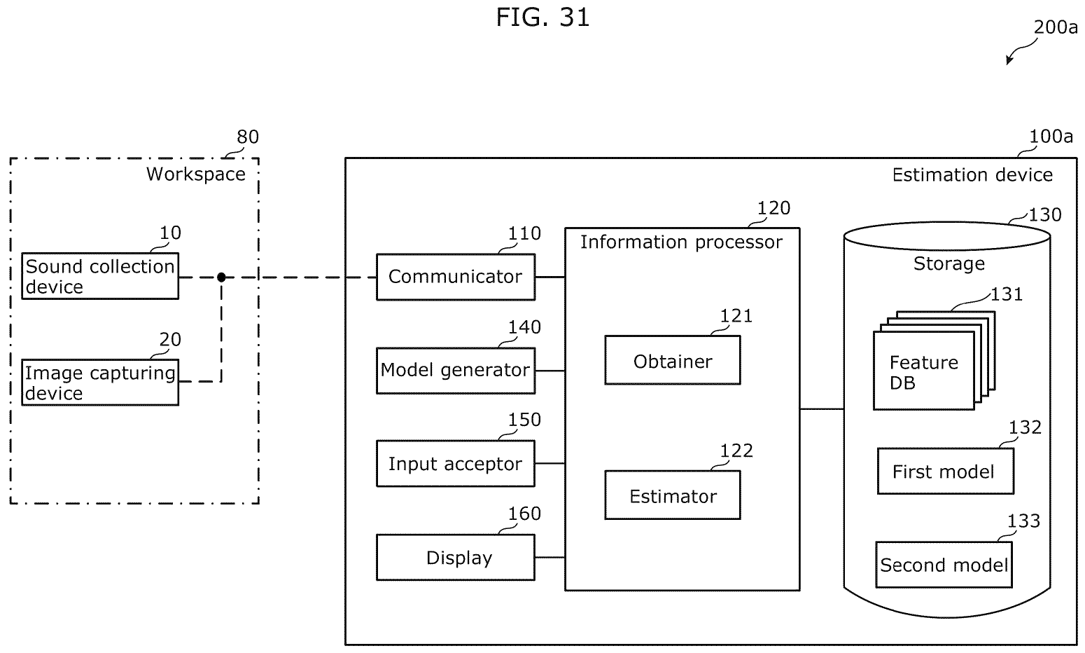

FIG. 31 is a block diagram illustrating an example of the functional configuration of an estimation system according to another embodiment. Although estimation device 100 of estimation system 200 according to the embodiment was described as a server device as an example, estimation device 100 need not be a server device. For example, in estimation system 200a according to the other embodiment, estimation device 100a may be a stationary computer device such as a personal computer or the like. Estimation device 100a differs from estimation device 100 in that display 160 is included. The following will describe only the differences.

### Display 160

Display 160 displays estimation results, for example. Display 160 is, for example, a display device that displays image information including text or the like, and is a display including, for example, a liquid crystal (LC) panel or an organic electroluminescence (EL) panel or the like as the device which implements the display.

Note that estimation device 100a may include a sound collector and an imager, for example, and may be installed in at least one workspace 80. “Including a sound collector and an imager” may be a state in which sound collection device 10 and image capturing device 20 are connected through wired or wireless communication, or in which a single device includes sound collection device 10 and image capturing device 20. Estimation device 100a may be communicatively connected to a server device or an information terminal of a user, for example. In this case, estimation device 100a may store the estimation result in storage 130 for a predetermined period of time (e.g., one day, several days, one week, or the like), output the estimation result to the server device or the information terminal, or output the estimation result each time an estimation is made. The server device may be a cloud server. The information terminal may be a stationary computer device such as a personal computer, or may be a portable computer device such as a tablet terminal.

Although implemented by a plurality of devices in the foregoing embodiments, for example, each of estimation systems 200 and 200a may instead be implemented as a single device. Additionally, if the systems are implemented by a plurality of devices, the plurality of constituent elements provided in estimation systems 200 and 200a may be distributed among the plurality of devices in any manner. Additionally, for example, a server device capable of communicating with estimation system 200 or 200a may include a plurality of constituent elements included in information processor 120.

For example, the method through which the devices communicate with each other in the foregoing embodiments is not particularly limited. Additionally, a relay device (not shown) may relay the communication among the devices.

Additionally, processing executed by a specific processing unit in the foregoing embodiments may be executed by a different processing unit. Additionally, the order of multiple processes may be changed, and multiple processes may be executed in parallel.

Additionally, in the foregoing embodiments, the constituent elements may be implemented by executing software programs corresponding to those constituent elements. Each constituent element may be realized by a program executor such as a CPU or a processor reading out and executing a software program recorded into a recording medium such as a hard disk or semiconductor memory.

Each constituent element may be implemented by hardware. For example, each constituent element may be circuitry (or integrated circuitry). This circuitry may constitute a single overall circuit, or may be separate circuits. The circuitry may be generic circuitry, or may be dedicated circuitry.

The general or specific aspects of the present disclosure may be implemented by a system, a device, a method, an integrated circuit, a computer program, or a computer-readable recording medium such as a CD-ROM. These forms may also be implemented by any desired combination of systems, devices, methods, integrated circuits, computer programs, and recording media.

For example, the present disclosure may be implemented as an estimation method executed by a computer such as estimation device 100, or as a program for causing a computer to execute such an estimation method. The present disclosure may also be realized as a program for causing a general-purpose computer to operate as estimation device 100 according to the foregoing embodiments. The present disclosure may be implemented as a non-transitory computer-readable recording medium in which the program is recorded.

Additionally, embodiments achieved by one skilled in the art making various conceivable variations on the embodiment, embodiments achieved by combining constituent elements and functions from the embodiment as desired within a scope which does not depart from the spirit of the present disclosure, and the like are also included in the present disclosure.

### INDUSTRIAL APPLICABILITY

According to the present disclosure, tasks in which transparent objects are handled can be estimated accurately, which makes it possible to accurately ascertain work times and the like. This in turn makes it possible to improve the efficiency of work in sites such as factories or logistics facilities.

1. An estimation method, performed by a computer, of estimating a task performed by a worker, the estimation method comprising:
obtaining data of a task sound that accompanies the task and that has been collected; and
estimating whether the worker is performing a task in which a transparent object is handled, by inputting the data of the task sound into a first model that has been trained.

2. The estimation method according to claim 1, further comprising:
obtaining data of an image in which the worker performing the task appears, the data of the image corresponding to the data of the task sound;
estimating whether the worker is performing the task in which the transparent object is handled, by inputting the data of the image into a second model that has been trained; and
estimating whether the worker is performing the task in which the transparent object is handled, based on a result of the estimating using the first model and a result of the estimating using the second model.

3. The estimation method according to claim 1, further comprising:
obtaining data of an image in which the worker performing the task appears, the data of the image corresponding to the data of the task sound; and
estimating whether the worker is performing the task in which the transparent object is handled, by inputting the data of the task sound and the data of the image into the first model.

4. The estimation method according to claim 1, further comprising:
estimating whether the worker is performing the task in which the transparent object is handled, based on a similarity between a feature of the task sound output from the first model and a feature, stored in storage in advance, of a task sound of the task in which the transparent object is handled.

5. The estimation method according to claim 1, further comprising:
estimating whether the worker is performing the task in which the transparent object is handled, based on a similarity of a feature of the task sound output from the first model to each of (i) a feature of a task sound, stored in advance in storage, of the task in which the transparent object is handled and (ii) a feature of a task sound, stored in advance in the storage, from which the worker can be erroneously estimated to be performing the task in which the transparent object is handled.

6. The estimation method according to claim 5,
wherein the worker is estimated to be performing the task in which the transparent object is handled when the similarity of the feature of the task sound output from the first model to the feature of the task sound of the task in which the transparent object is handled exceeds the similarity to the feature of the task sound from which the worker can be erroneously estimated to be performing the task in which the transparent object is handled.

7. The estimation method according to claim 5, further comprising:
when a similarity of (i) a feature of a task sound of a task in which a non-transparent object different from the transparent object is handled, the feature being obtained by inputting, to the first model, data of the task sound of the task in which the non-transparent object is handled, to (ii) the feature of the task sound of the task in which the transparent object is handled, exceeds a threshold, determining that the task sound of the task in which the non-transparent object is handled is a task sound that can be erroneously estimated as the task sound of the task in which the transparent object is handled; and
storing, in the storage, the feature of the task sound of the task in which the non-transparent object is handled as the feature of the task sound that can be erroneously estimated.

8. The estimation method according to claim 1,
wherein the data of the task sound includes data of a sound in an inaudible range.

9. An estimation device that estimates a task performed by a worker, the estimation device comprising:
an obtainer that obtains data of a task sound that accompanies the task and that has been collected; and
an estimator that estimates whether the worker is performing a task in which a transparent object is handled by inputting the data of the task sound into a first model that has been trained.

10. A non-transitory computer-readable recording medium having recorded thereon a program for causing a computer to execute the estimation method according to claim 1.
